(19) United States
(12) Patent Application Publication
(10) Pub. No.: US 2018/0229563 A1
(43) Pub. Date: Aug. 16, 2018

(54) MOBILE PONTOON AND FERRY CROSSING EQUIPMENT, A PONTOON AND A FERRY ACCOMPANYING THIS EQUIPMENT

(71) Applicant: E-INTERPROJECT SP. Z O.O., POSWIETNE (PL)

(72) Inventors: BOGDAN BERENT, POSWIETNE (PL); JANUSZ FLORCZYK, POSWIETNE (PL); JOZEF FRET, POSWIETNE (PL); ROBERT FRET, POSWIETNE (PL); ANDRZEJ GAJEWSKI, POSWIETNE (PL)

(21) Appl. No.: 15/570,738

(22) PCT Filed: Apr. 15, 2016
(86) PCT No.: PCT/PL2016/000041

§ 371 Date: Oct. 30, 2017

(30) Foreign Application Priority Data
Apr. 30, 2015 (PL) P.412186

(51) Int. Cl. B60F 3/00; B63B 35/36

(52) U.S. Cl. CPC B60F 3/0061; B63B 35/36; B63B 2747/00; B60F 3/0038; B60F 3/0092

(57) ABSTRACT

Mobile pontoon and ferry crossing equipment as well as a pontoon and a ferry accompanying this equipment, whereas crossing equipment comprises at least one foldable ferry or one foldable pontoon, each of which has a compact modular design composed of float modules and equipped with self-aligned joining elements that stabilized these modules, according to the invention is characterized by the fact that the foldable ferry (1) or foldable pontoon (2) in its closed condition for transportation forms a semi-trailer or a trailer, whose self-supporting chassis (3) is at the same time a basic float module of the foldable ferry (1) or foldable pontoon (2) respectively.

The subject matter of this invention is mobile pontoon and ferry crossing equipment, and the pontoon and the ferry which accompany this equipment.

There are several known solutions of various designs related to mobile crossing equipment and its components, described in numerous publications and patents.

For example, from the patent application U.S. Pat. No. 6,167,582B1 the embodiment of a collapsible pontoon is known to us, which comprises two internal and two external float modules adjoining each other in the longitudinal direction and joined together with a hinged connection in the transversal direction. Each of these float modules contains an upper section of a roadway and float modules located one next to the other comprise additional features in the form of connecting pins that protect them against spreading apart. Once unfolded this pontoon has a compact modular design of a crossing set, and once folded it has a compact modular design of a transport set, however, it does not form an autonomous crossing and transportation set, since it is intended to be open and closed on the water and to be transported with an additional car vehicle chassis equipped with a specialised boom.

From the patent application U.S. Pat. No. 4,386,441A the embodiment of a collapsible pontoon is known which comprises two pairs of vertically positioned float modules, in which float modules are joined together with a hinged connection where the edges of these modules meet in their lower part, whereas in the external module of each pair a drive wheel is located, and in the second external module a chamber is located, into which part of this wheel is retracted when the pontoon is in its closed position. Pairs of vertically positioned float modules are joined together with a hinged connection where the edges of these modules meet in the upper part. Once unfolded this pontoon has a compact modular design of a crossing set, and once folded it has a compact modular design of a transport set with the use of drive wheels. This pontoon, however, is not an autonomous crossing set, because its folding and unfolding on the water is only possible with the use of additional equipment. At the same time the applied design solution of a pontoon makes it useless in terms of practical use of the crossing equipment.

In turn, from the patent application DE4437071A1 the embodiment of a pontoon is known, in which individual positive-displacement chambers of the pontoon are separated by vertical walls and joined together with drains to a joint discharge channel. From this channel water is discharged outside by means of a suction pipe and a pump. The solution applied ensures that the use of the pontoon is in no manner influenced by its tightness resulting from its design.

From patent applications US2002148398A1 and US2002088388A1 an embodiment of a pontoon developed on a trailer is known, comprising a main frame and stretching out longitudinal and transverse beams. In its open position the wheels of a trailer are recessed while floats are retractable sideways.

This invention is a new design solution of mobile pontoon and ferry crossing equipment with an increased loading capacity, which in emergency situations provides for effective (in terms of labour intensity and required time) development of pontoon water crossings, ferry and pontoon crossings, and ferry crossings with repeatable modules (collapsible ferries and pontoons) with an increased displacement, transported as a whole in the form of special autonomous trailers or semi-trailers.

Mobile pontoon and ferry crossing equipment according to the invention, consisting of at least a collapsible ferry or a collapsible pontoon, each of which has a compact modular design made up of float modules and equipped with self-aligned joining elements that stabilise these modules, is distinguished by the fact that the collapsible ferry or pontoon when closed and transported forms a trailer or semi-trailer, whose self-supporting chassis is at the same time an additional float module of the collapsible ferry or pontoon respectively.

A foldable pontoon to secure movement using the crossing equipment, which has a compact modular design made up of float modules, and equipped with self-aligned joining elements that stabilise these modules, is distinguished by the fact that when closed and transported forms a trailer or semi-trailer, with a self-supporting chassis being a uniform lower part of a trailer or semi-trailer with additional float modules that form an upper part of a trailer or a semi-trailer, whereas when opened the self-supporting chassis of a semi-trailer is at the same time a basic middle float module of the pontoon, to which self-aligned single or combined in series additional float modules are attached.

As in the collapsible pontoon mentioned above, a self-aligned front float module or back float module is attached as an additional float module to a basic float module of the pontoon, as well as a self-aligned right-side float module or a left-side float module can be attached to the basic float module of the pontoon as an additional float module. Additional float modules of a collapsible pontoon are connected to another module of an additional collapse pontoon or ferry.

According to a beneficial embodiment of the invention, a basic float module of a collapsible pontoon forms an enclosure for, at least, the electrical power system or hydraulic system, front and rear supports and wheels on the suspension arms of a trailer or semi-trailer.

On float modules of a collapsible pontoon at least one track is determined by platforms and appropriate sloped thresholds.

Additional float modules of the collapsible pontoon are filled with a favourable light foamy structural material. Individual additional float modules are fitted with collapsible breakwaters.

A foldable ferry for securing movement in the crossing equipment, which has a compact, modular design composed of float modules and equipped with self-aligned joining elements that stabilise these modules, is distinguished by the fact that when closed and transported it forms a trailer or semi-trailer, with a self-supporting chassis being a uniform lower part of the trailer or semi-trailer and additional float modules being an upper part of the trailer or semi-trailer, whereas in its open position the self-supporting chassis of a trailer or a semi-trailer is at the same time a basic middle float module of a pontoon, to which self-aligning single or combined in series additional float modules are attached.

As in the collapsible ferry mentioned above, a right-side self-aligning float module or left-side float module is attached to the basic float module and forms an additional float module. Additional side float modules of a collapsible ferry are connected with another module of an additional collapsible ferry or pontoon.

One of the beneficial elements of the invention is that a basic float module of the collapsible ferry forms the basis for a ferry operator cabin and an enclosure for, at least, a combustion engine, an electrical power system, a hydraulic system, rear water propellers, front water propellers, side water propellers, front and rear supports and wheels on the suspension arms of a trailer or semi-trailer.

On float modules of a collapsible ferry at least one track, which is determined by platforms and appropriate sloped thresholds, is located.

Additional float modules are filled with a favourable light foamy structural material. Additional float modules are fitted with collapsible breakwaters.

The embodiment of this equipment according to the invention is presented in the following figures, in which

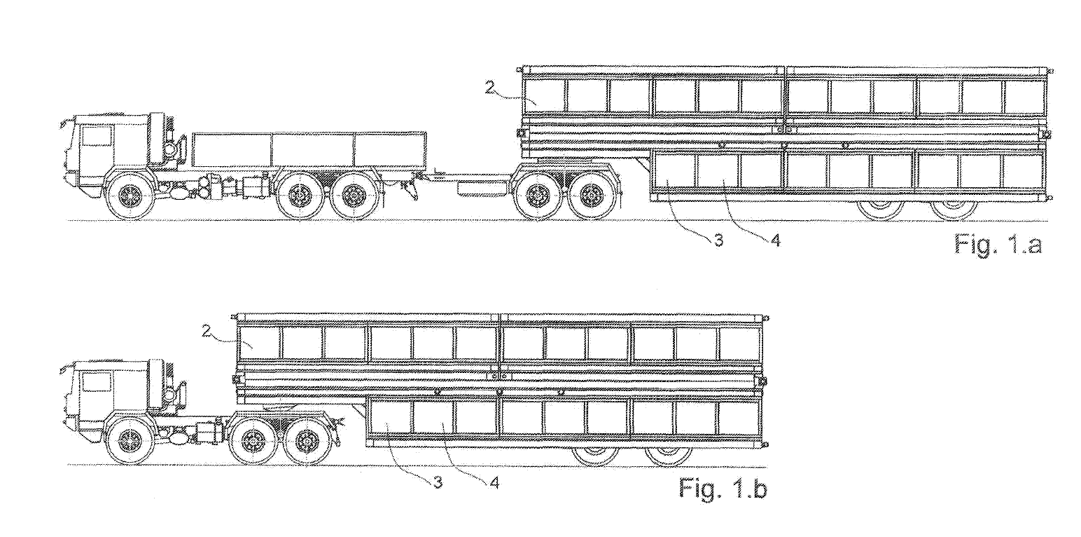

FIGS. 1.a and 1.b presents a transport set in which a single-track collapsible pontoon as a component of ferry and pontoon mobile crossing equipment is presented as a trailer or a semi-trailer respectively,

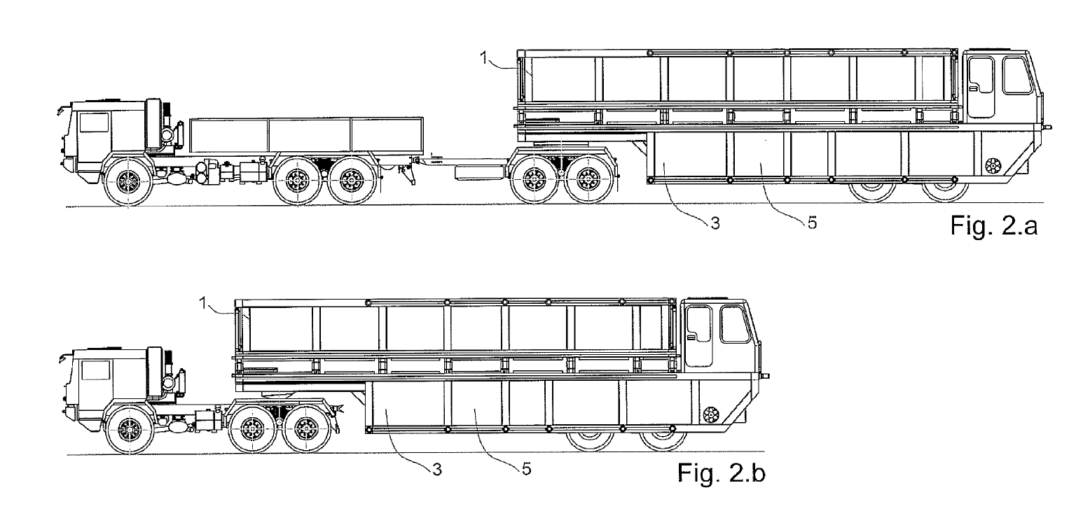

FIGS. 2.a and 2.b presents a transport set in which a single-track collapsible ferry as a component of ferry and pontoon mobile crossing equipment is presented as a trailer or a semi-trailer respectively,

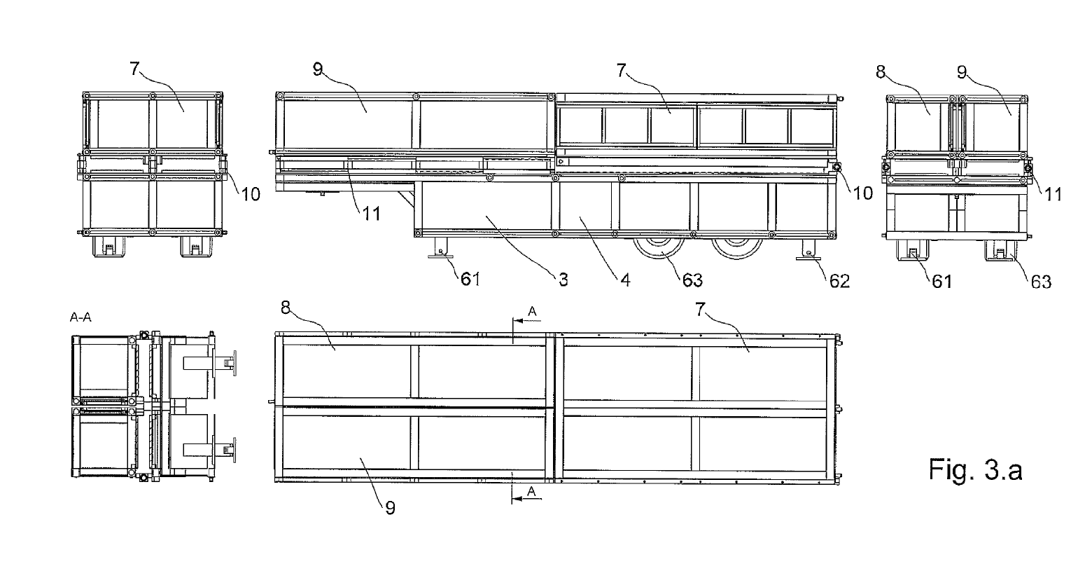

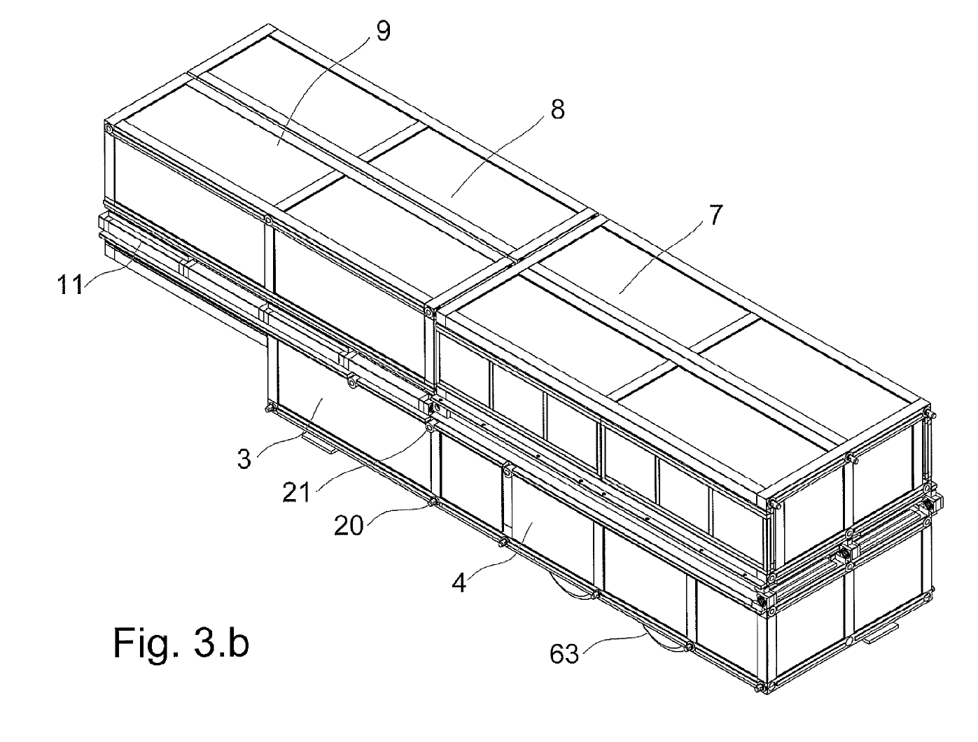

FIGS. 3.a and 3.b presents a collapsible ferry which in its closed condition forms a trailer (semi-trailer) in one of the configurations, in projections and a view,

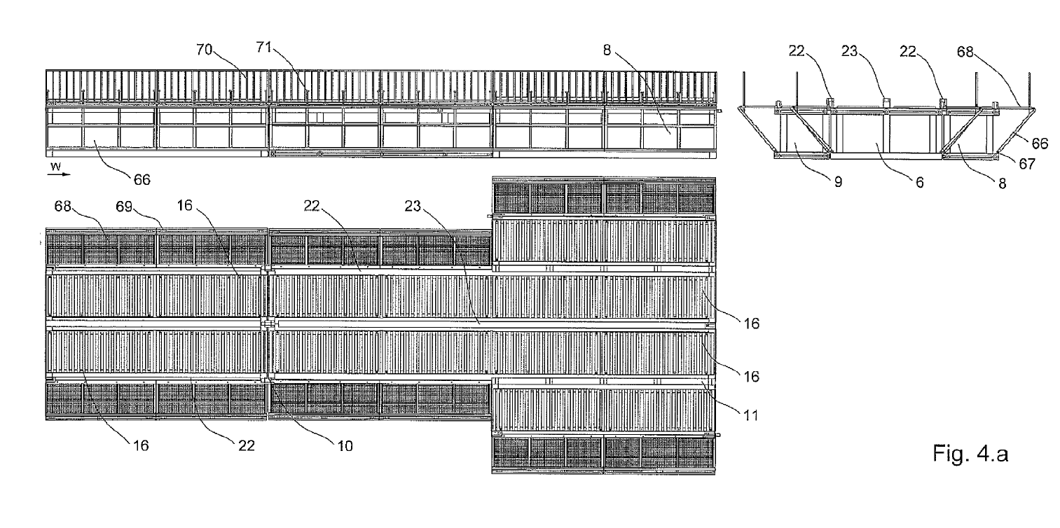

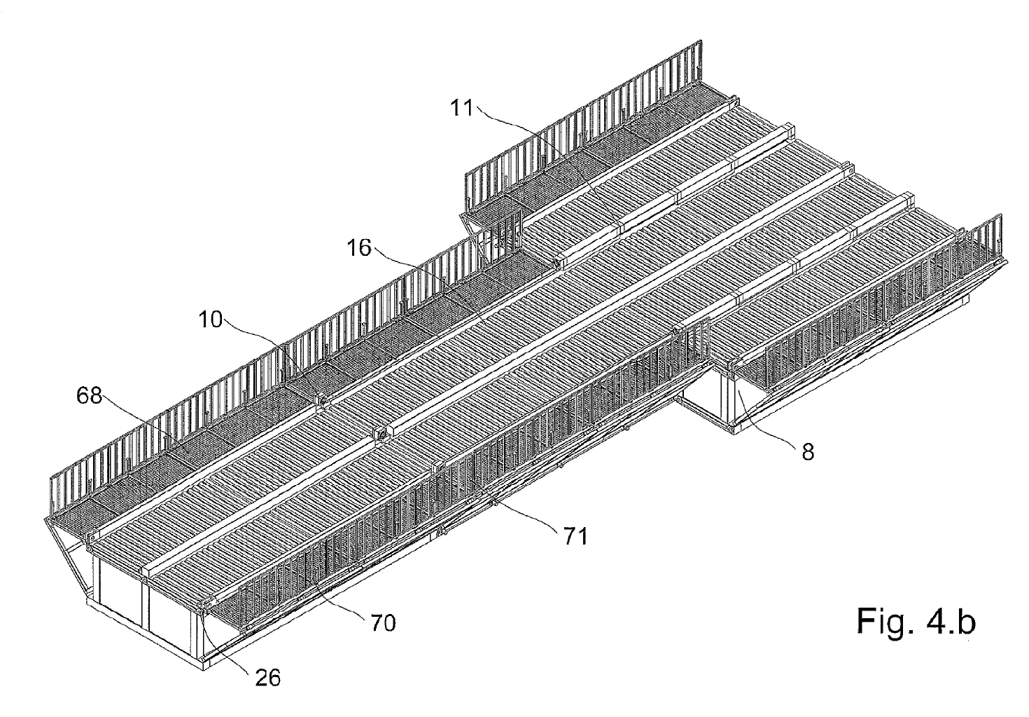

FIGS. 4.a and 4.b presents a collapsible floating pontoon in one of the configurations, in its open condition, in projections and a view respectively,

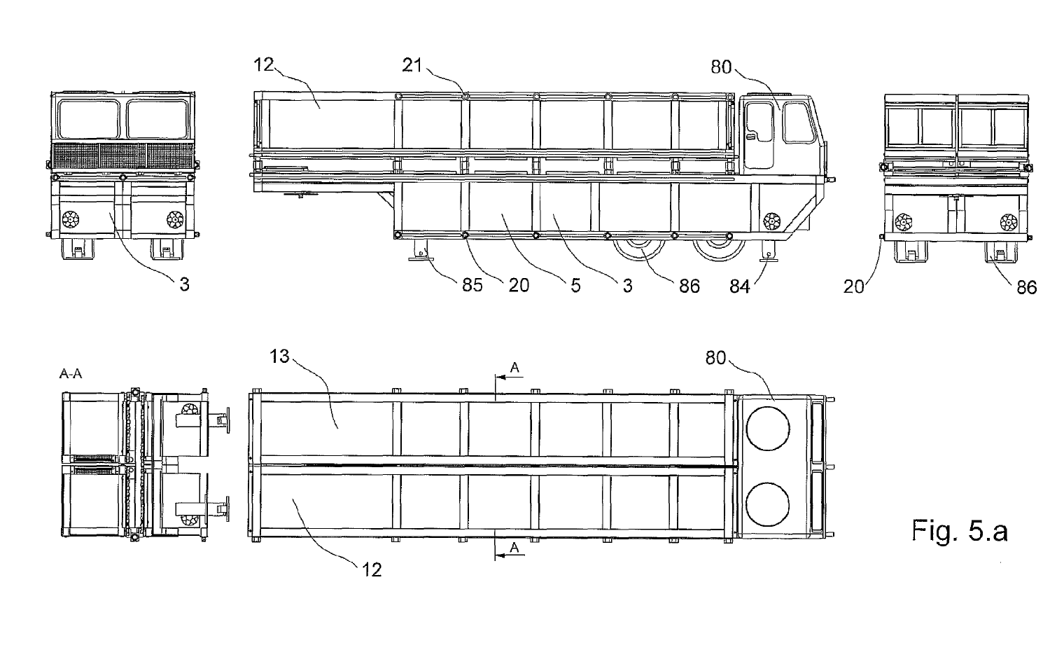

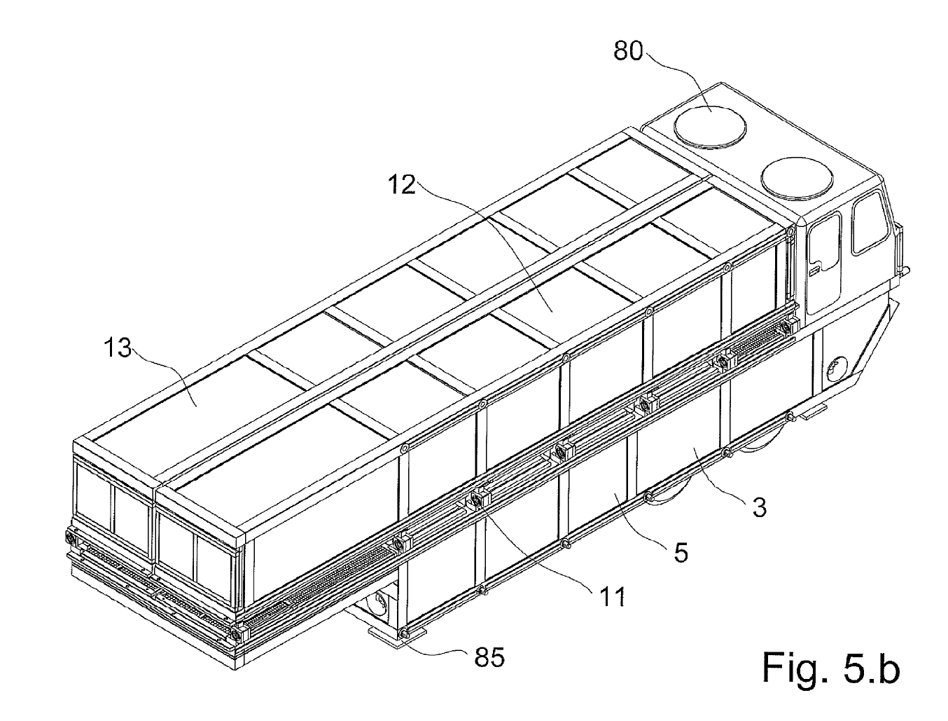

FIGS. 5.a and 5.b presents a collapsible ferry which in its closed condition forms a trailer (semi-trailer) in one of the configurations, in projections and a view respectively,

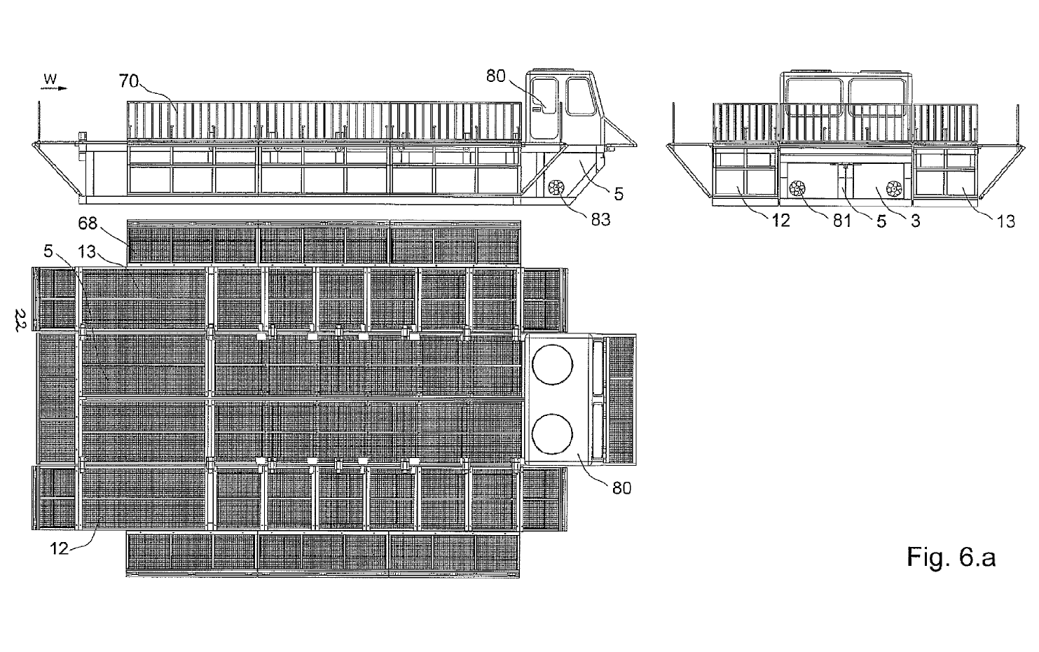

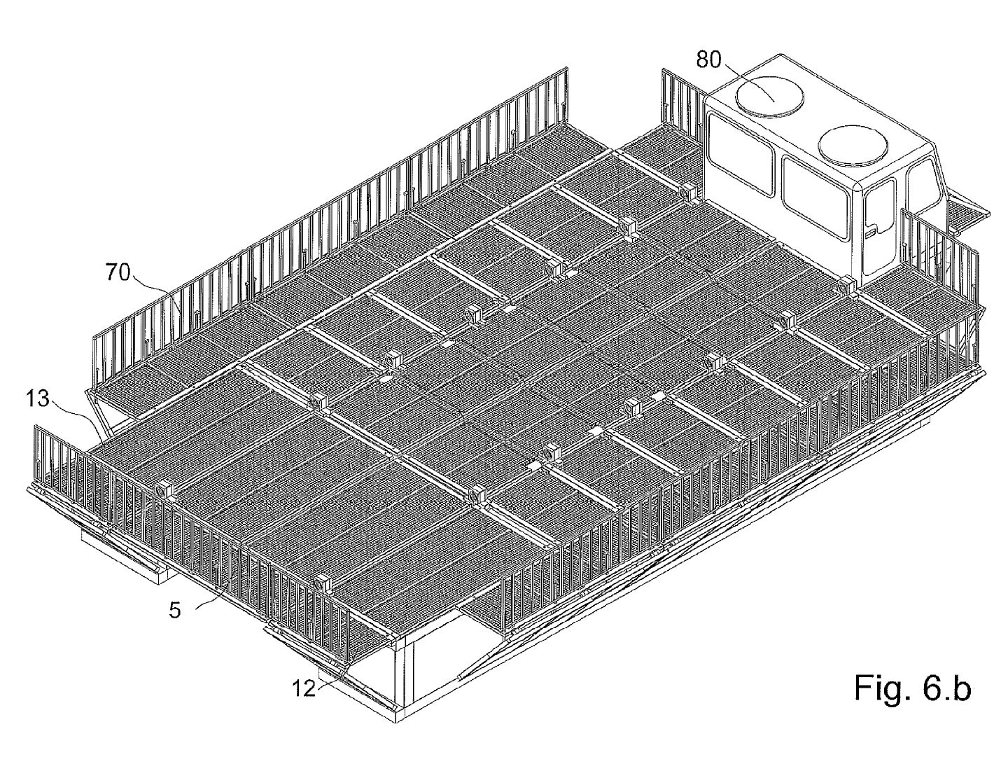

FIGS. 6.a and 6.b presents a collapsible floating ferry in one of the configurations, in its open condition, in projections and a view respectively,

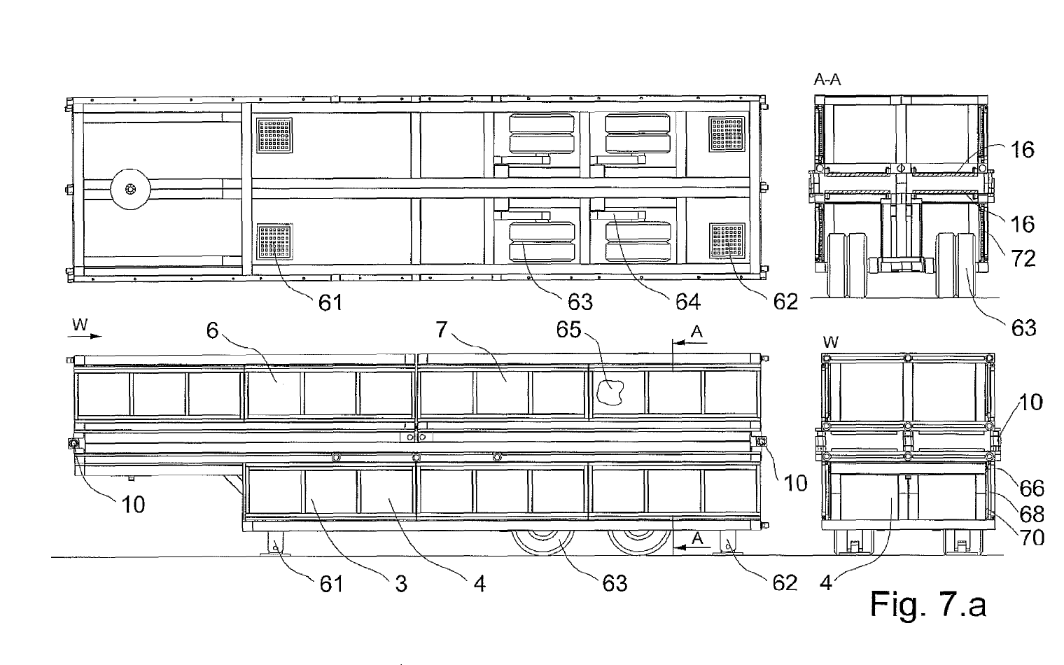

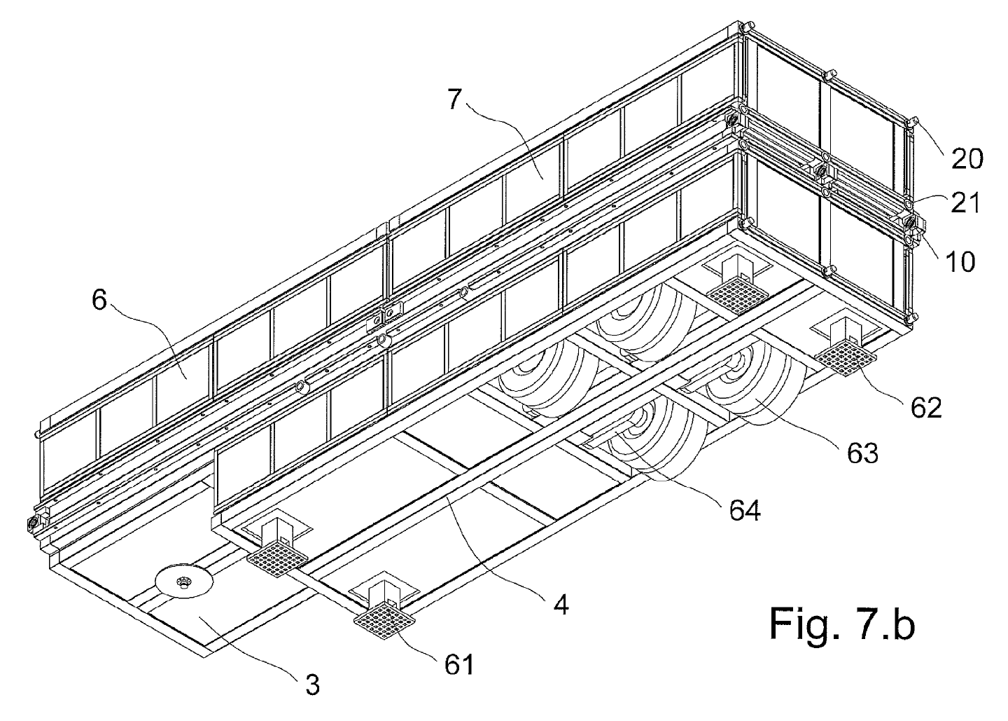

FIGS. 7.a and 7.b presents a single-track collapsible pontoon that in its closed condition forms a trailer (semi-trailer) in projections and a view,

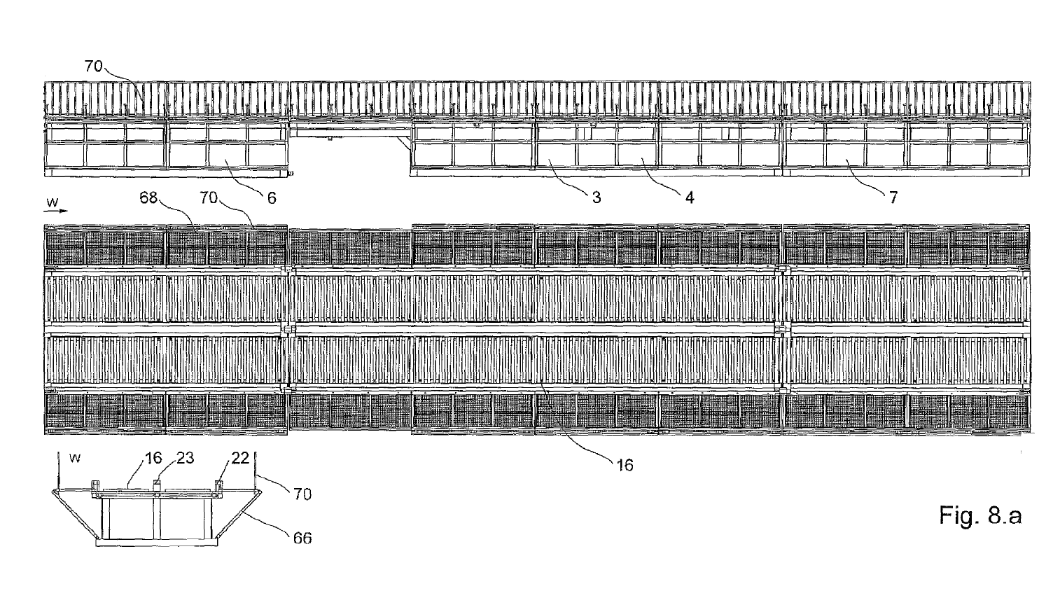

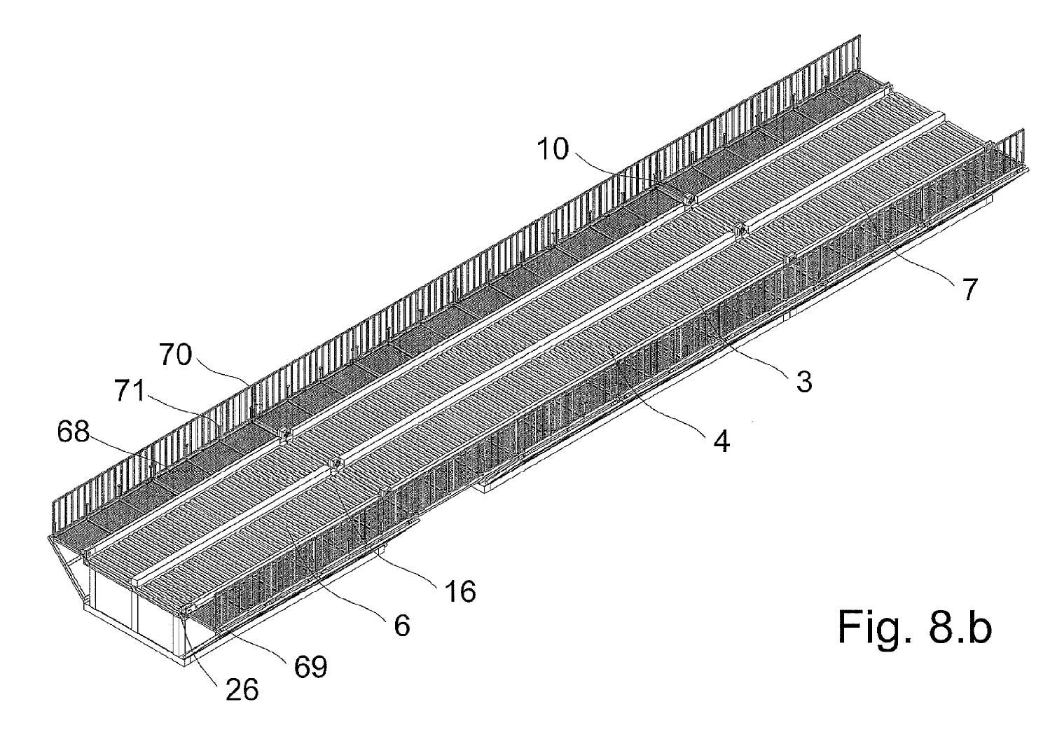

FIGS. 8.a and 8.b presents a single-track collapsible floating pontoon in its open condition, in projections and a view respectively,

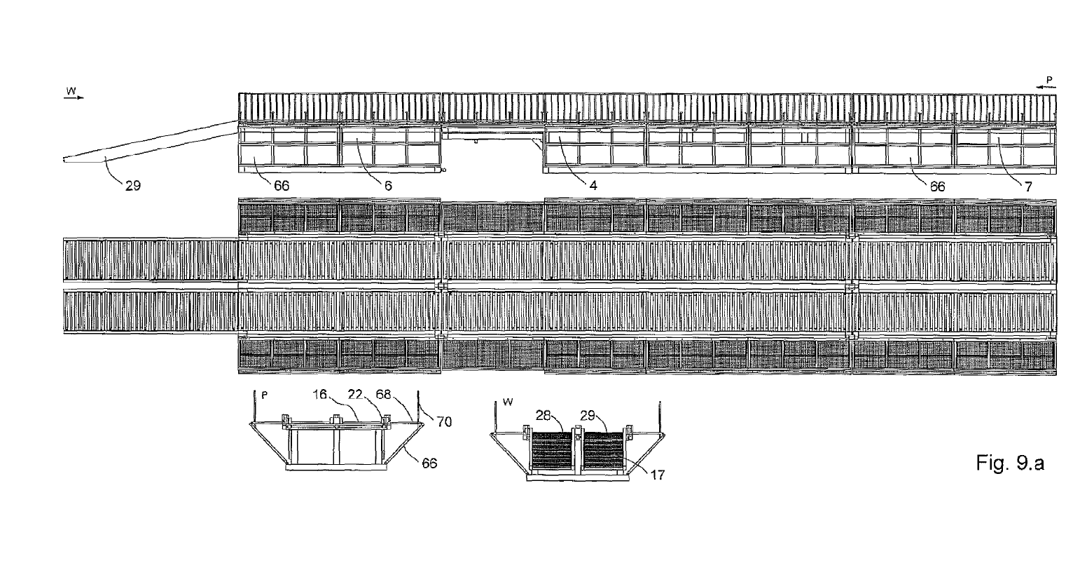

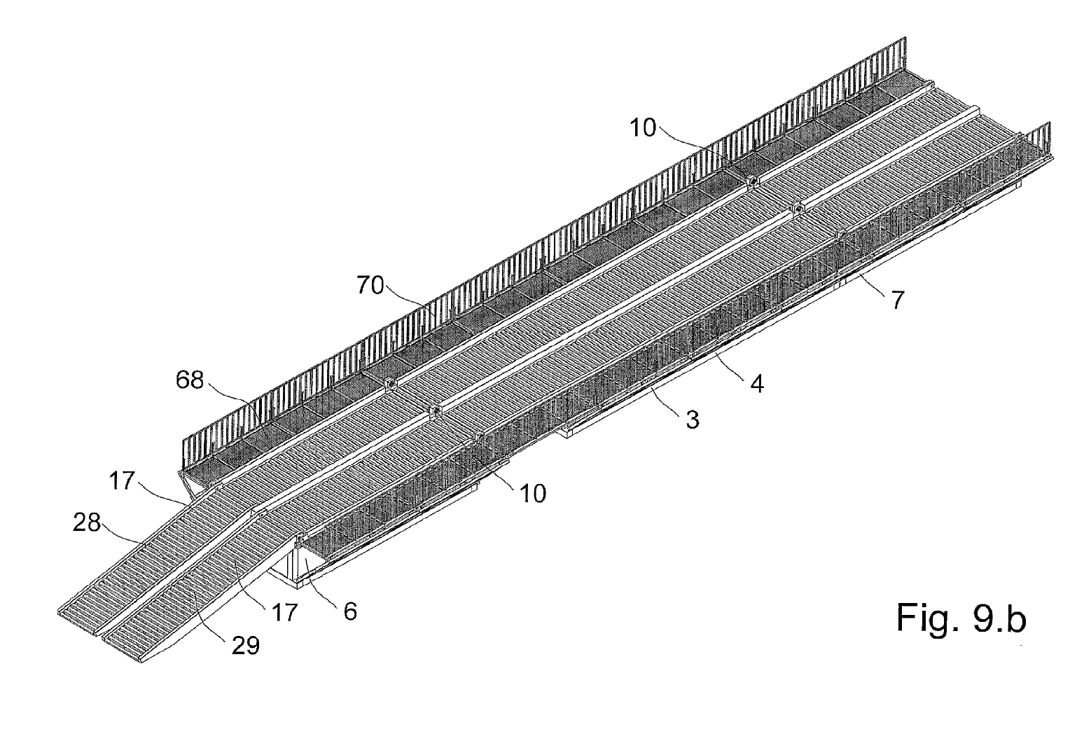

FIGS. 9.a and 9.b presents a single-track shore pontoon in its open condition in projections and a view,

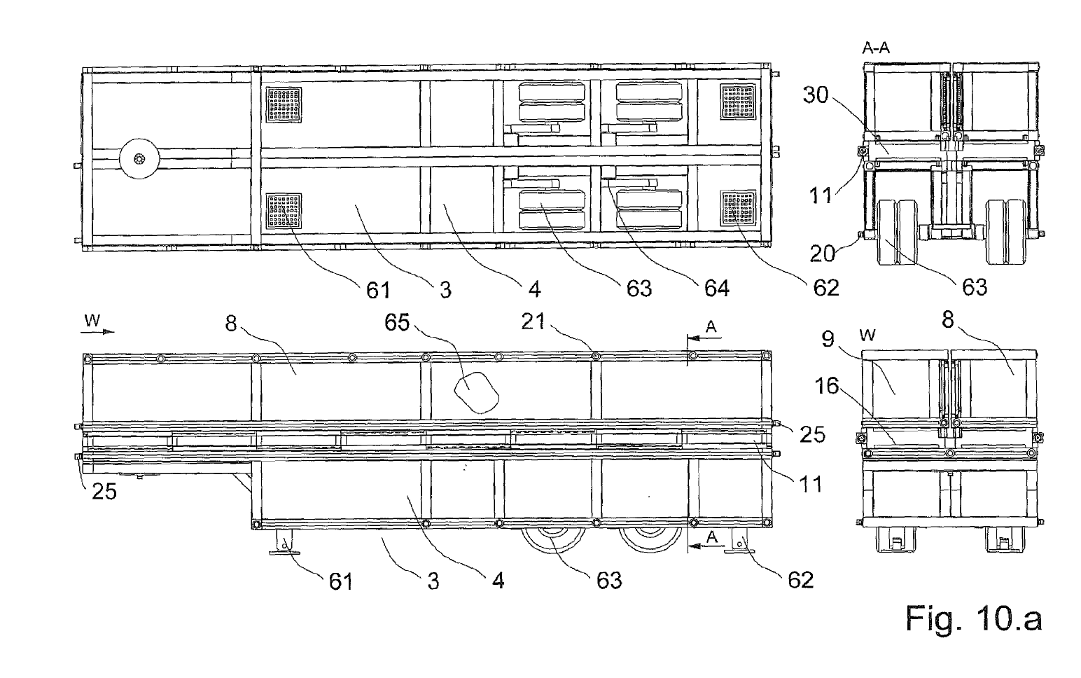

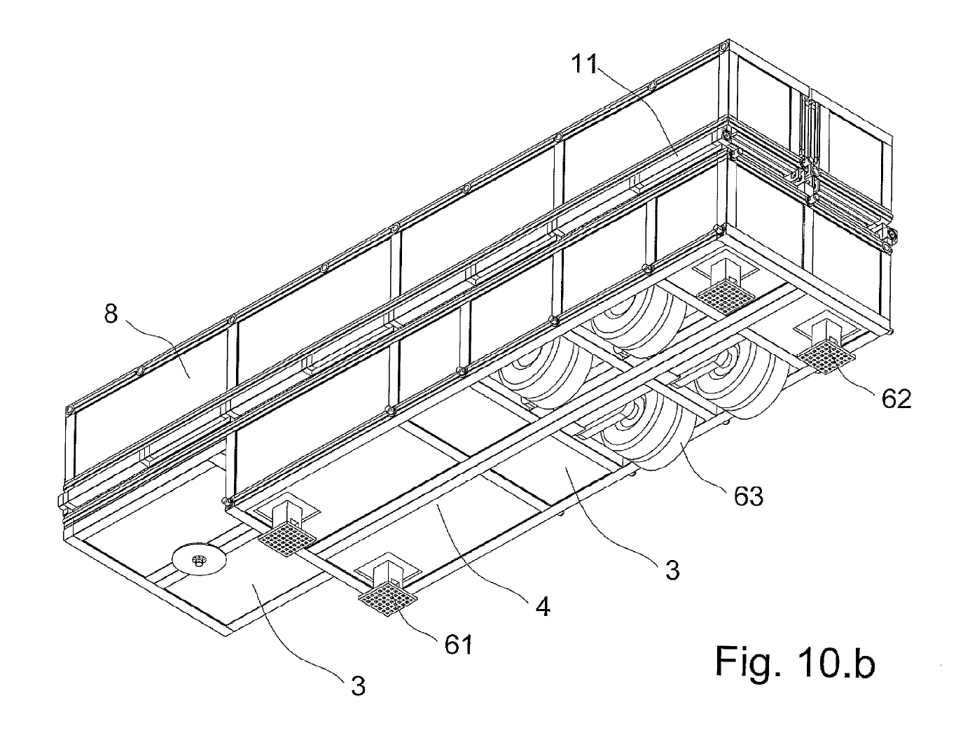

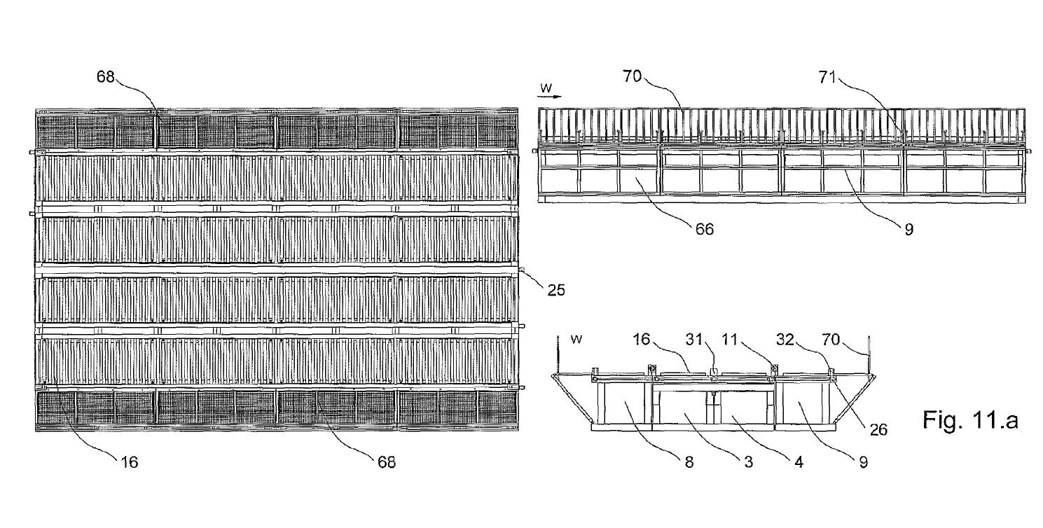

FIGS. 10.a and 10.b presents a double-track collapsible pontoon that in its closed condition forms a trailer (semi-trailer) in projections and a view,

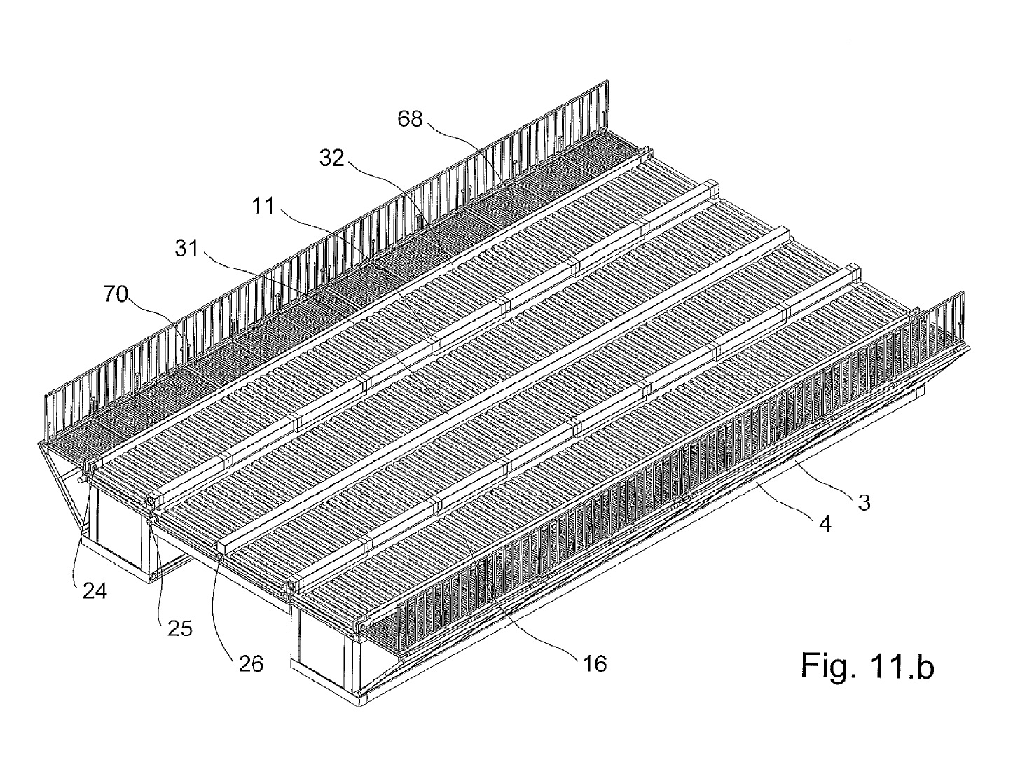

FIGS. 11.a and 11.b presents a collapsible double-track floating pontoon in its open condition in projections and a view respectively,

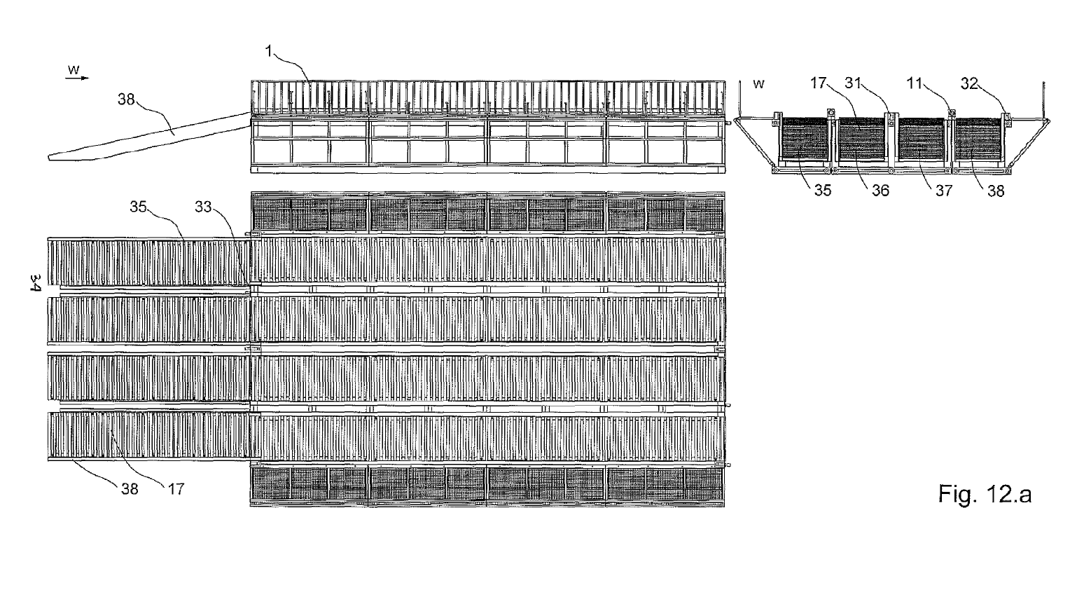

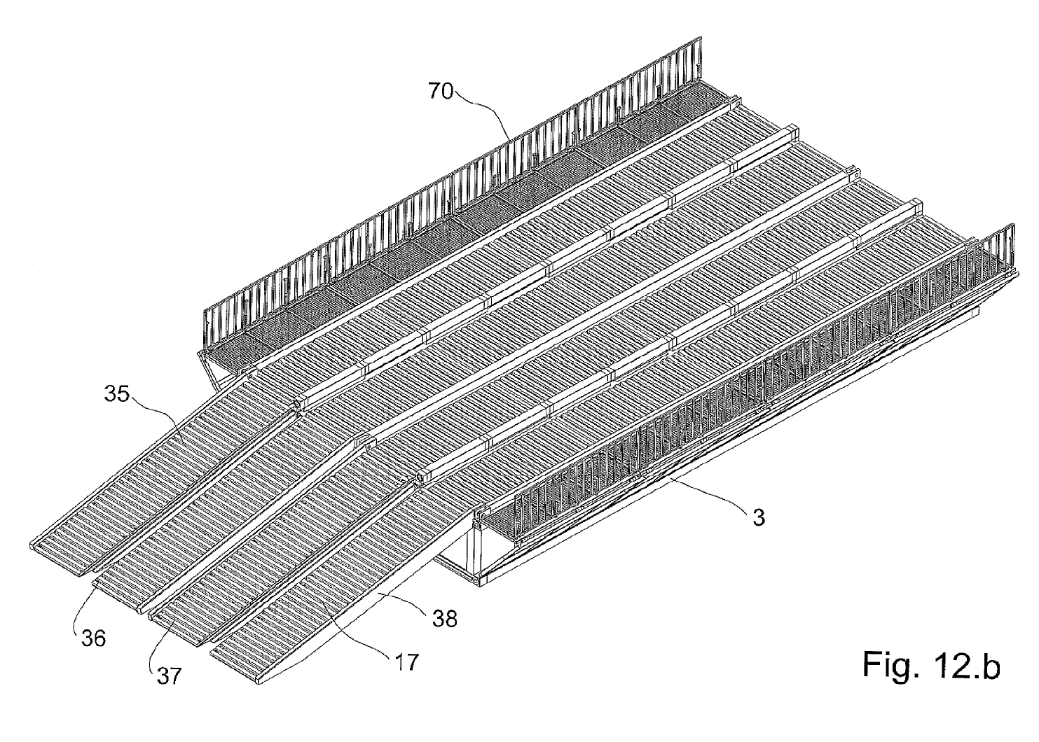

FIGS. 12.a and 12.b presents a double-track shore pontoon in its open condition in projections and a view,

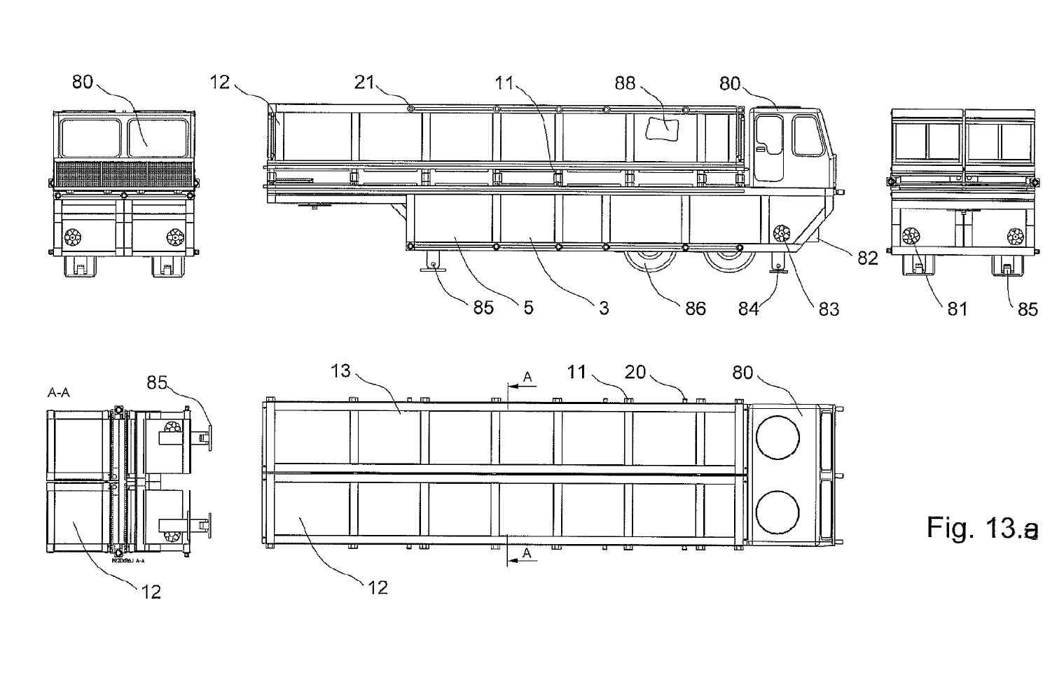

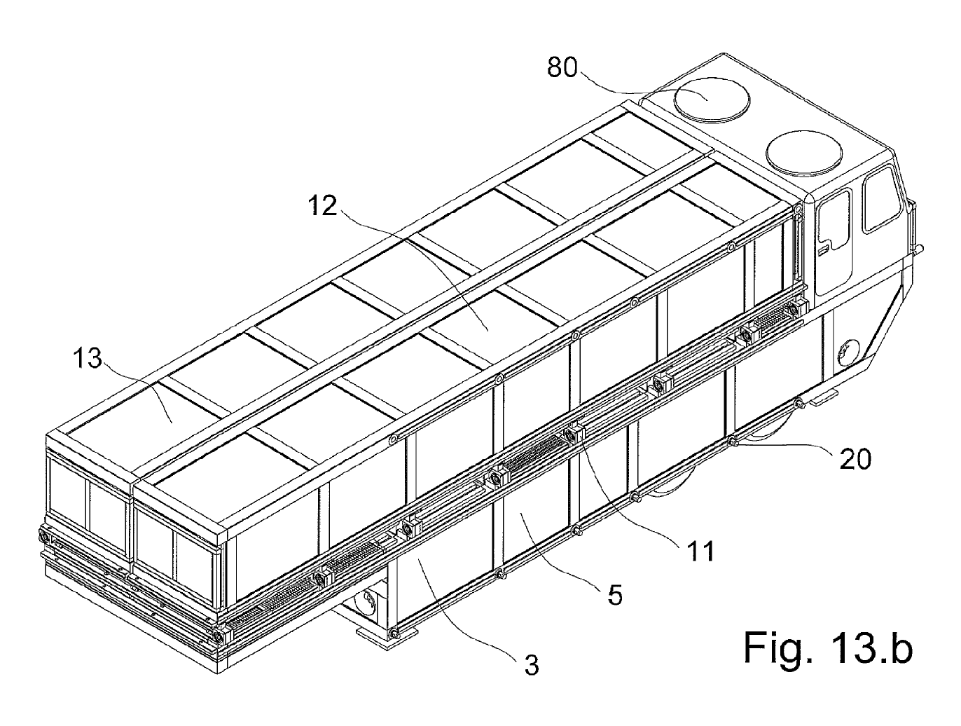

FIGS. 13.a and 13.b presents a single-track collapsible ferry that in its closed condition forms a trailer (semi-trailer) in projections and a view,

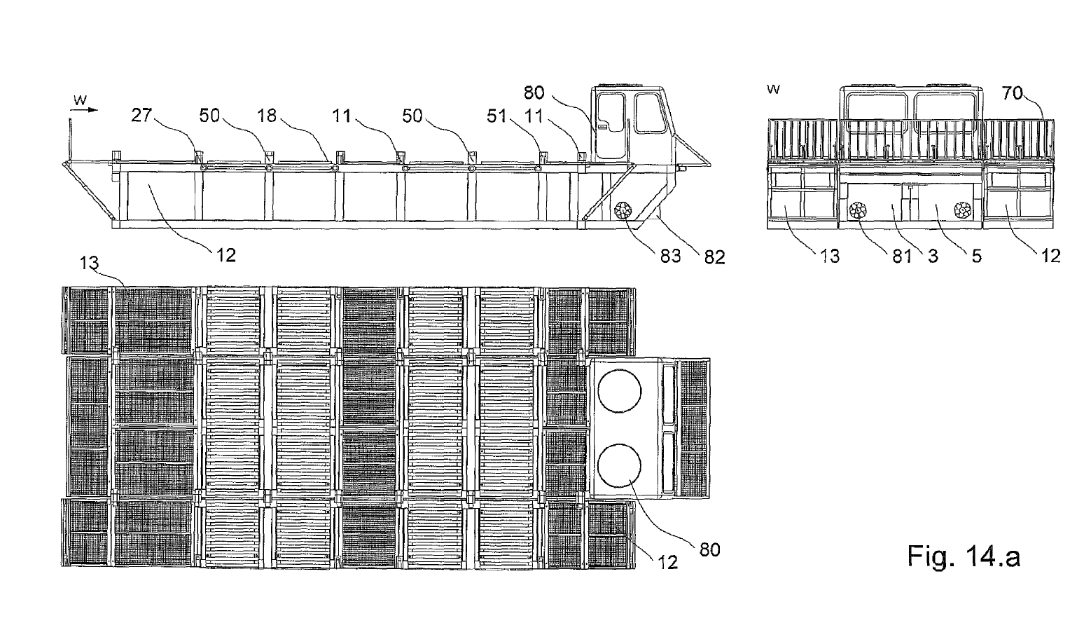

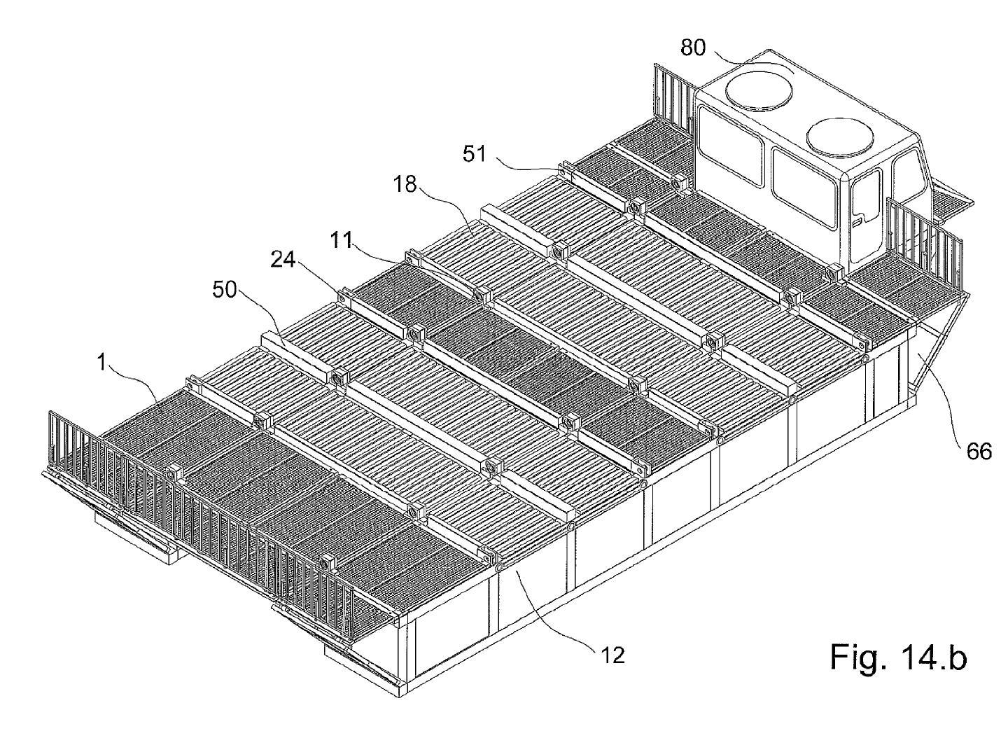

FIGS. 14.a and 14.b presents a collapsible single-track floating pontoon in its open condition in projections and a view respectively,

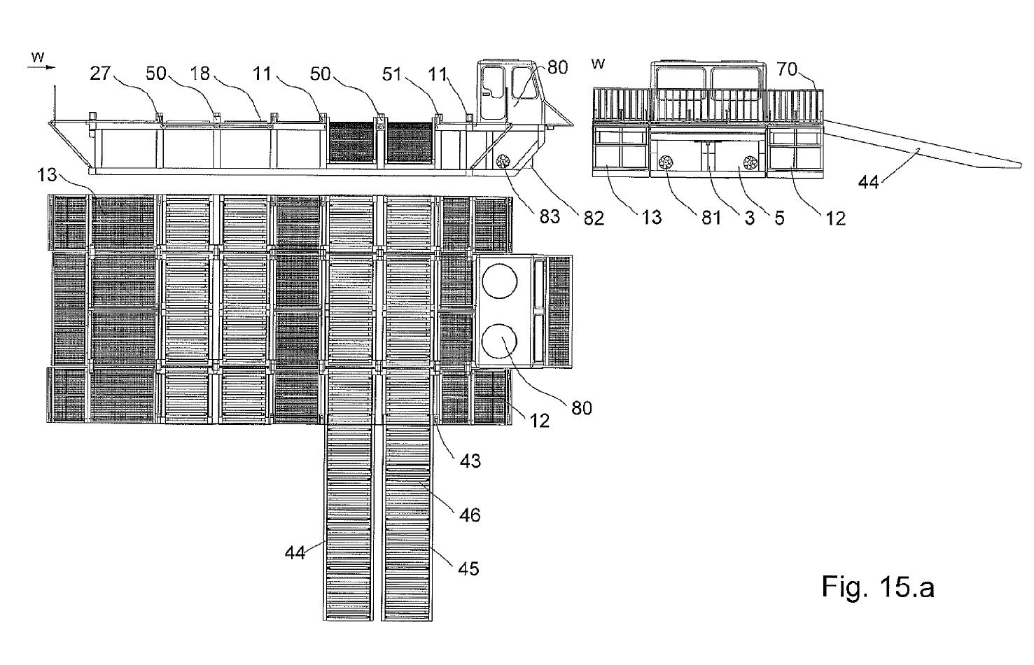

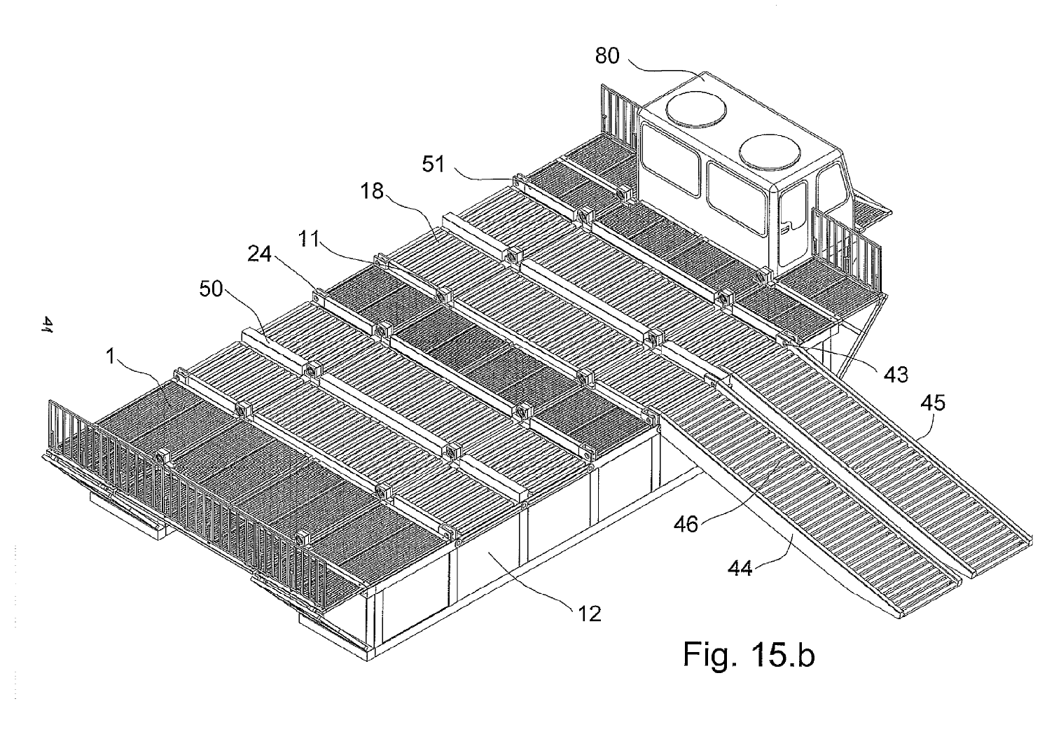

FIGS. 15.a and 15.b presents a single-track shore pontoon in its open condition in projections and a view,

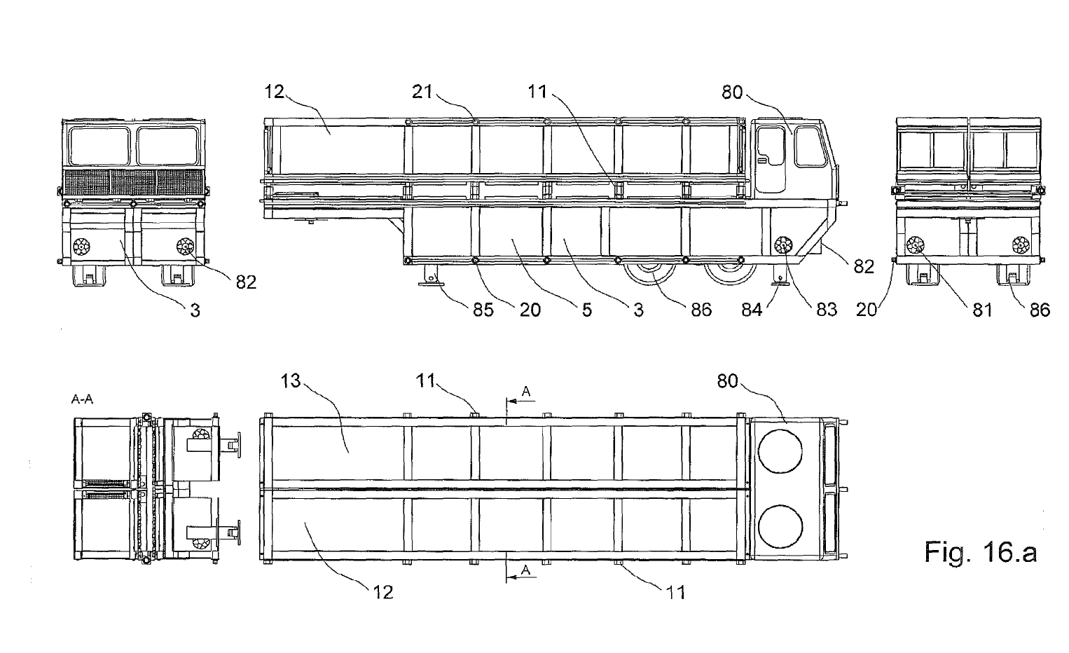

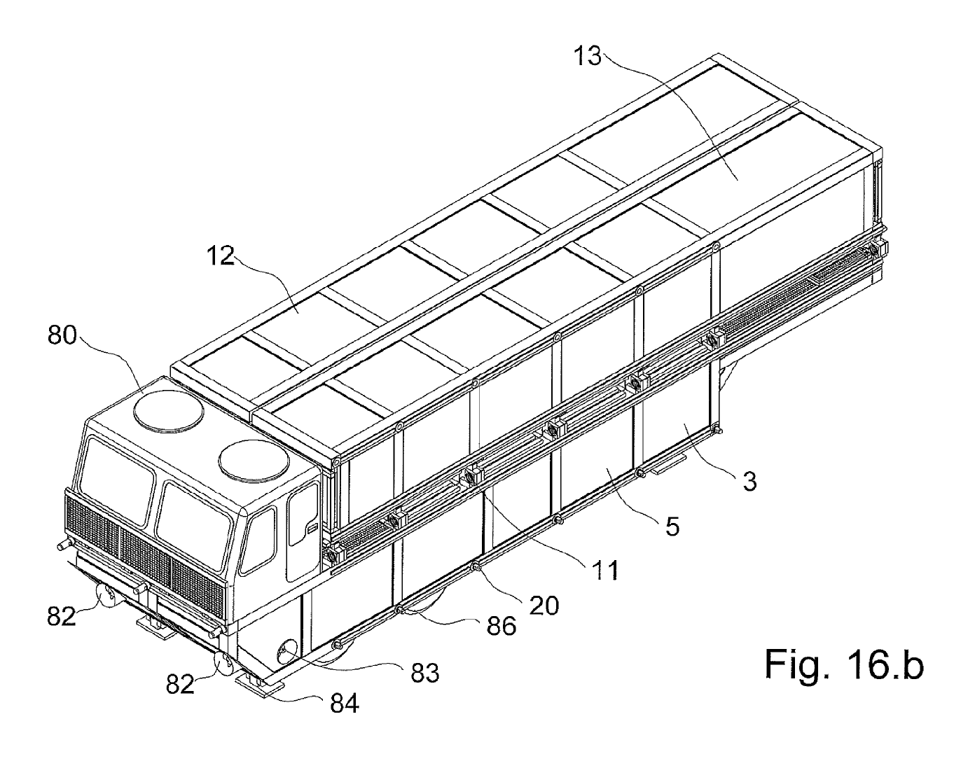

FIGS. 16.a and 16.b presents a double-track collapsible ferry that in its closed condition forms a trailer (semi-trailer) in projections and a view,

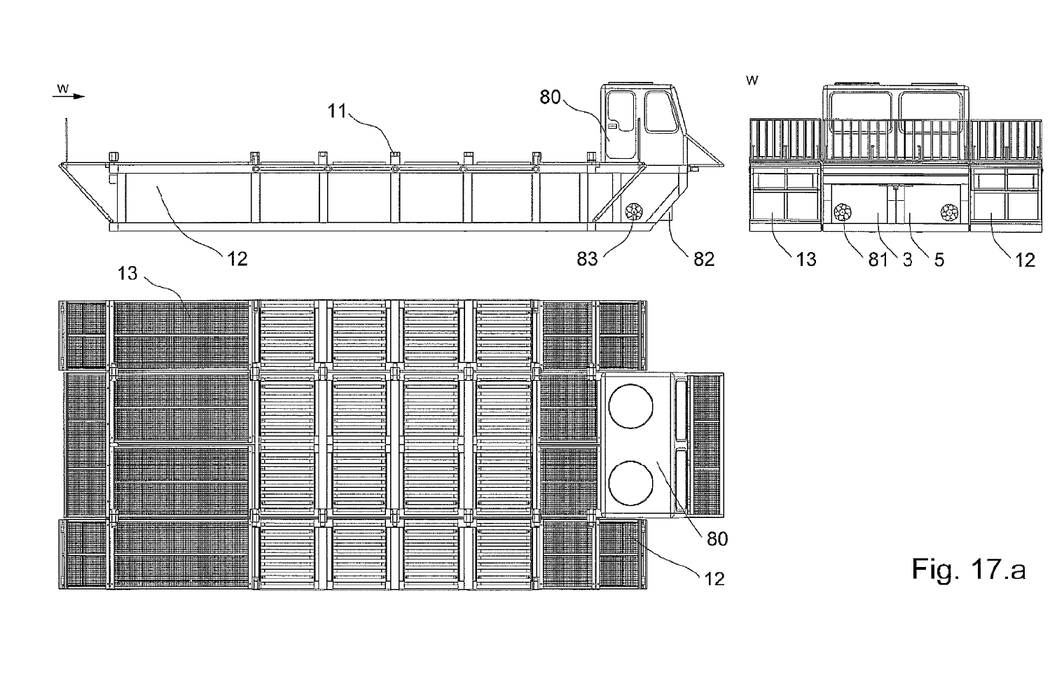

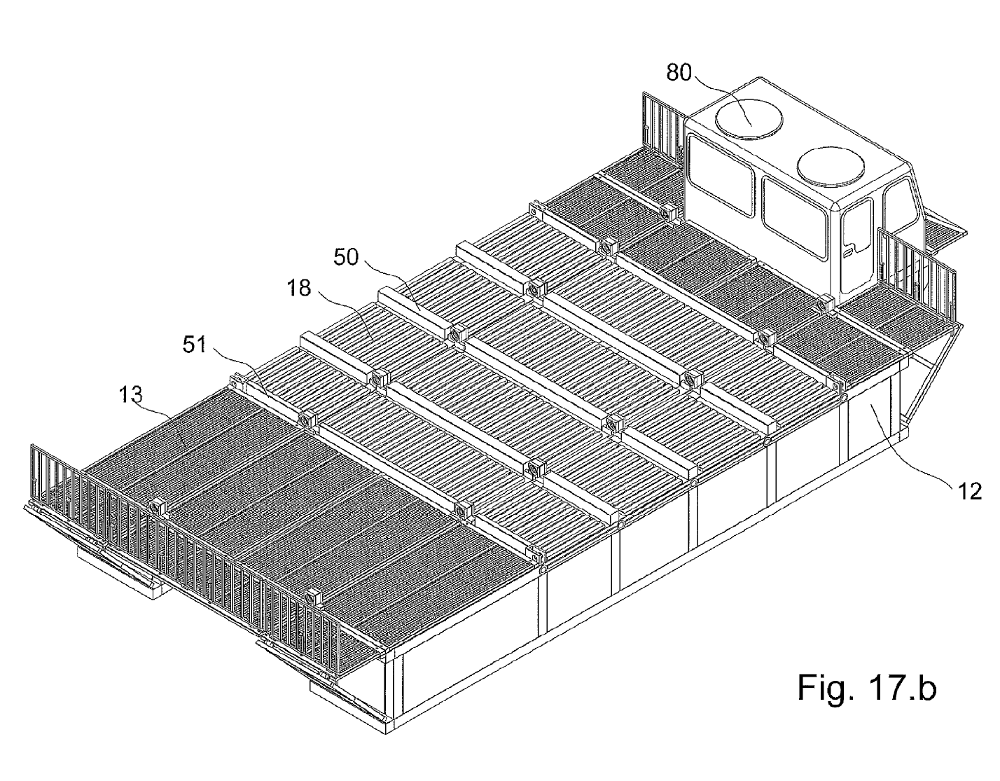

FIGS. 17.a and 17.b presents a collapsible double-track floating ferry in its open condition in projections and a view respectively,

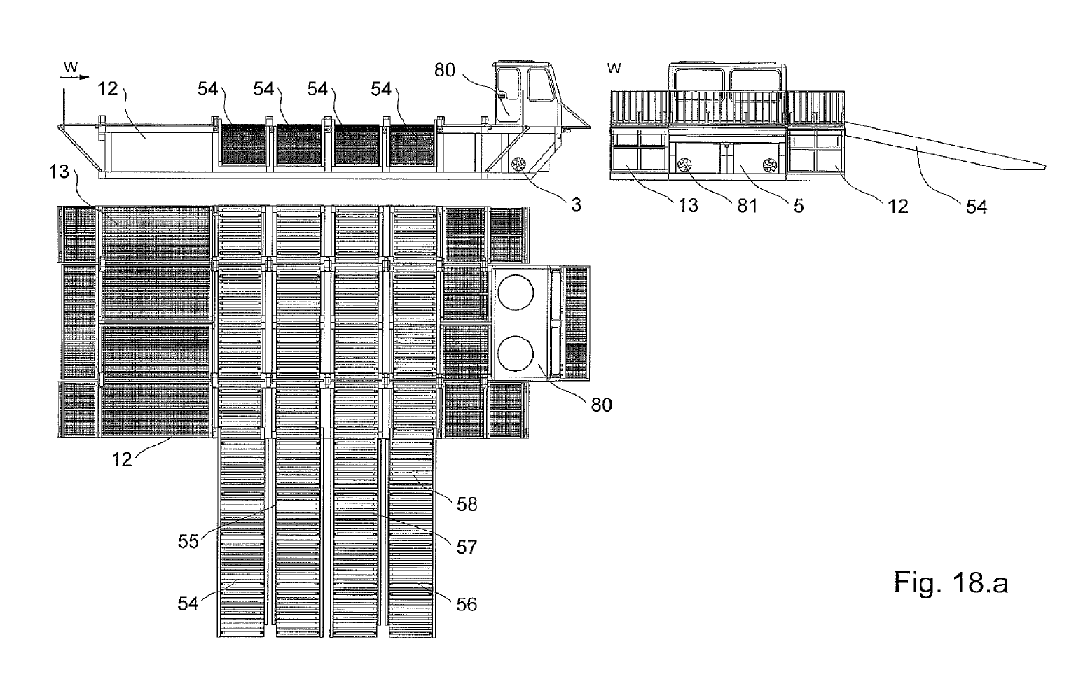

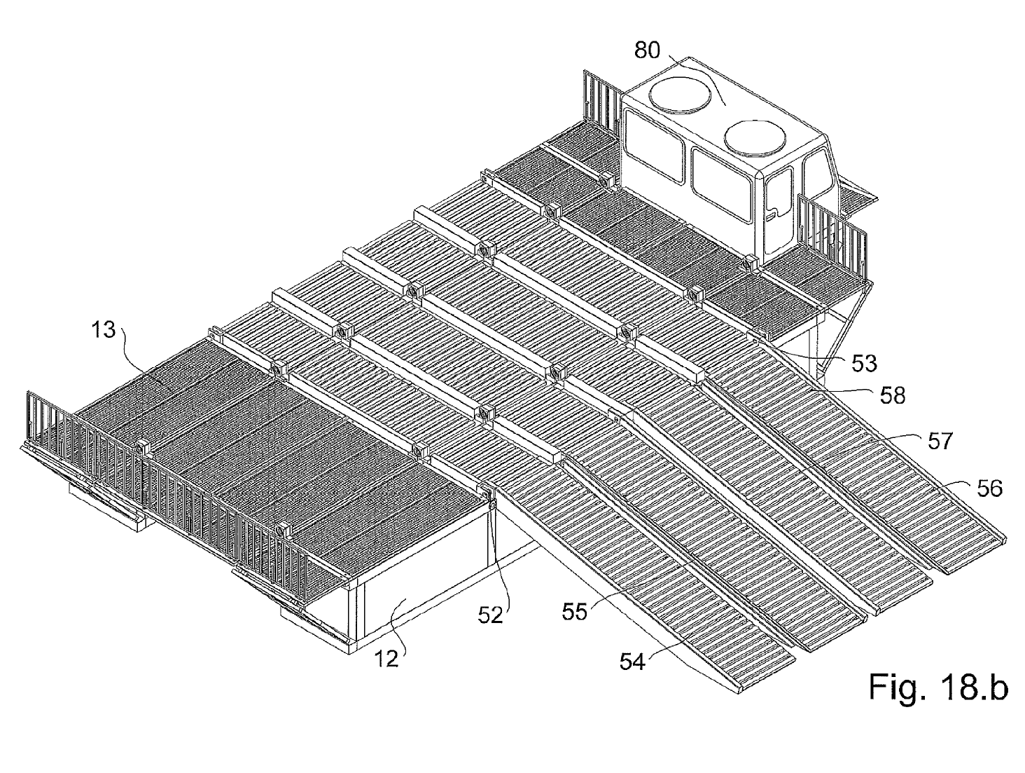

FIGS. 18.a and 18.b presents a double-track shore ferry in its open condition in projections and a view,

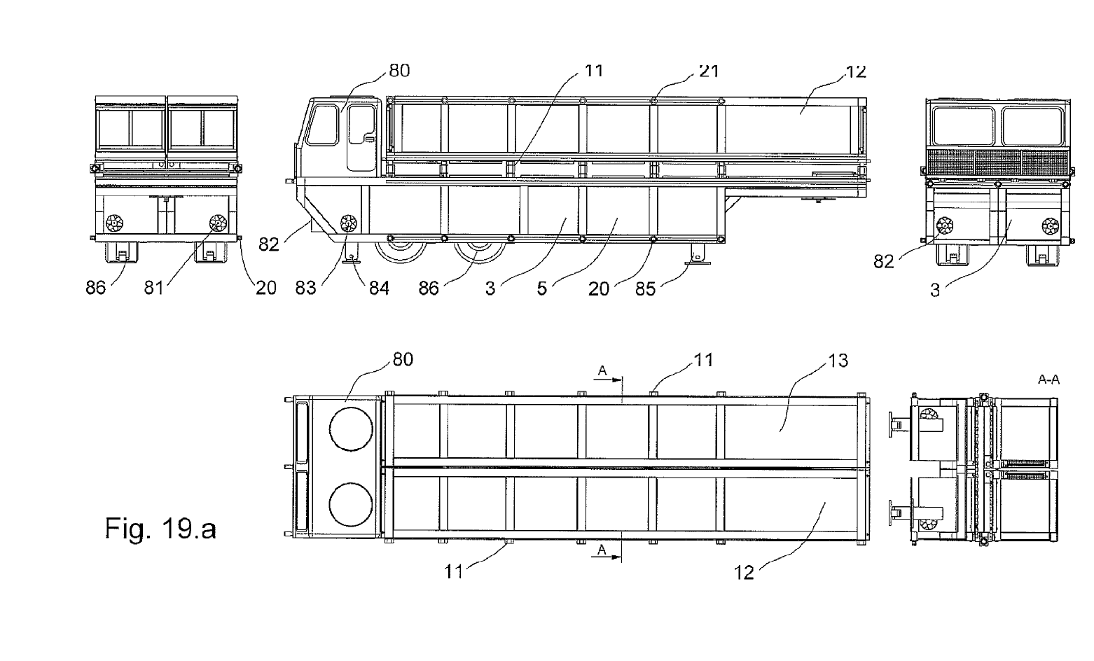

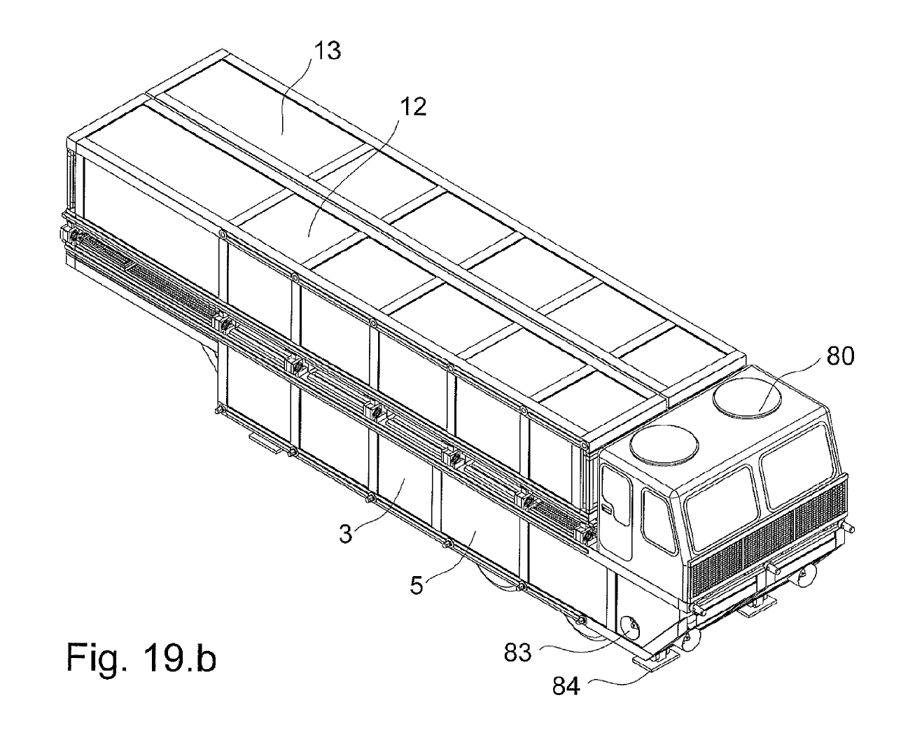

FIGS. 19.a and 19.b presents a double-track collapsible crossing ferry that in its closed condition forms a trailer (semi-trailer) in projections and a view,

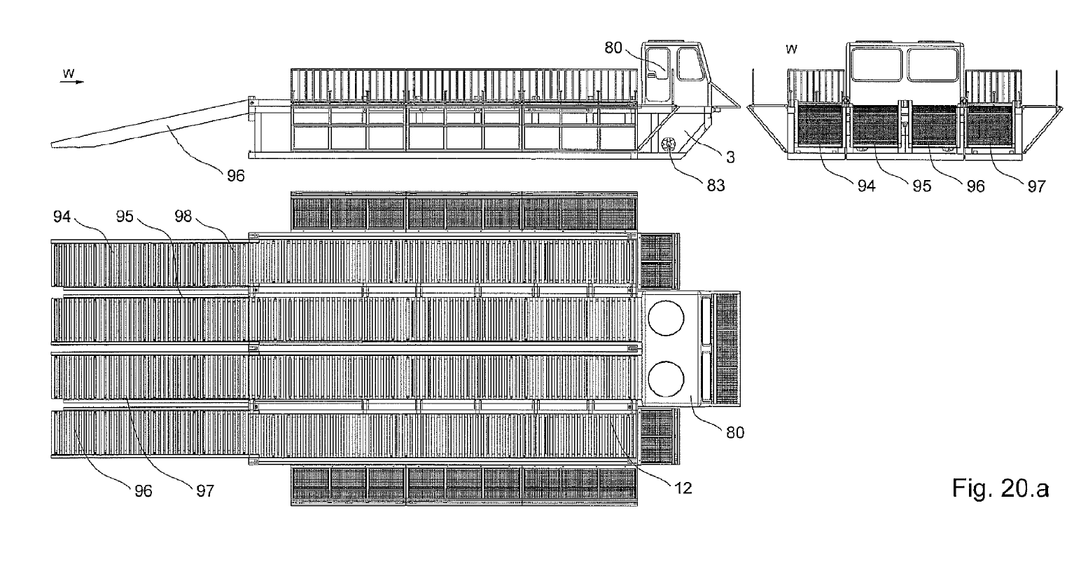

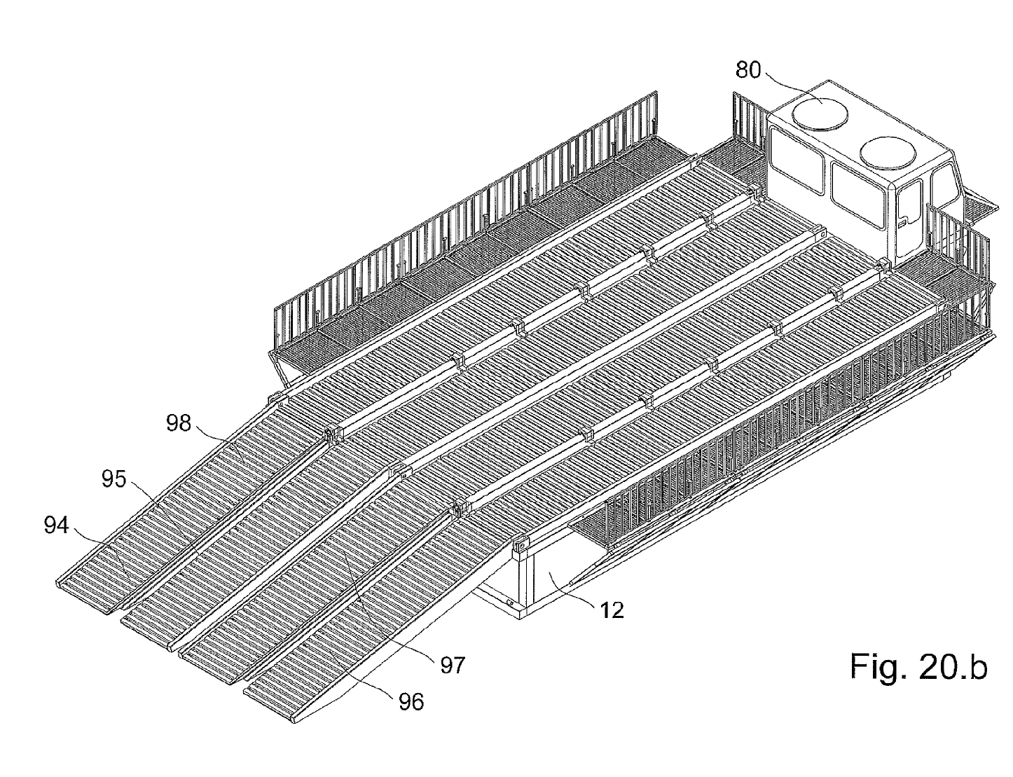

FIGS. 20.a and 20.b presents a double-track crossing ferry in its open condition in projections and a view,

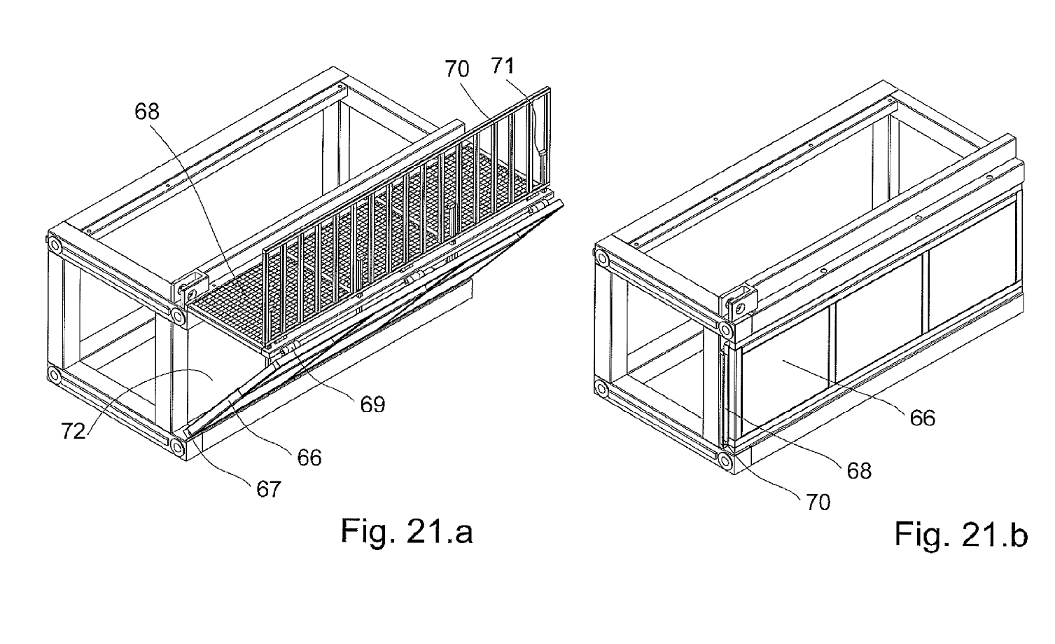

FIG. 21.a presents in a view a breakwater in its open condition with walking platforms and protective railings,

FIG. 21.b presents a breakwater with working platforms with protective railings folded in a niche of the side wall of the float module,

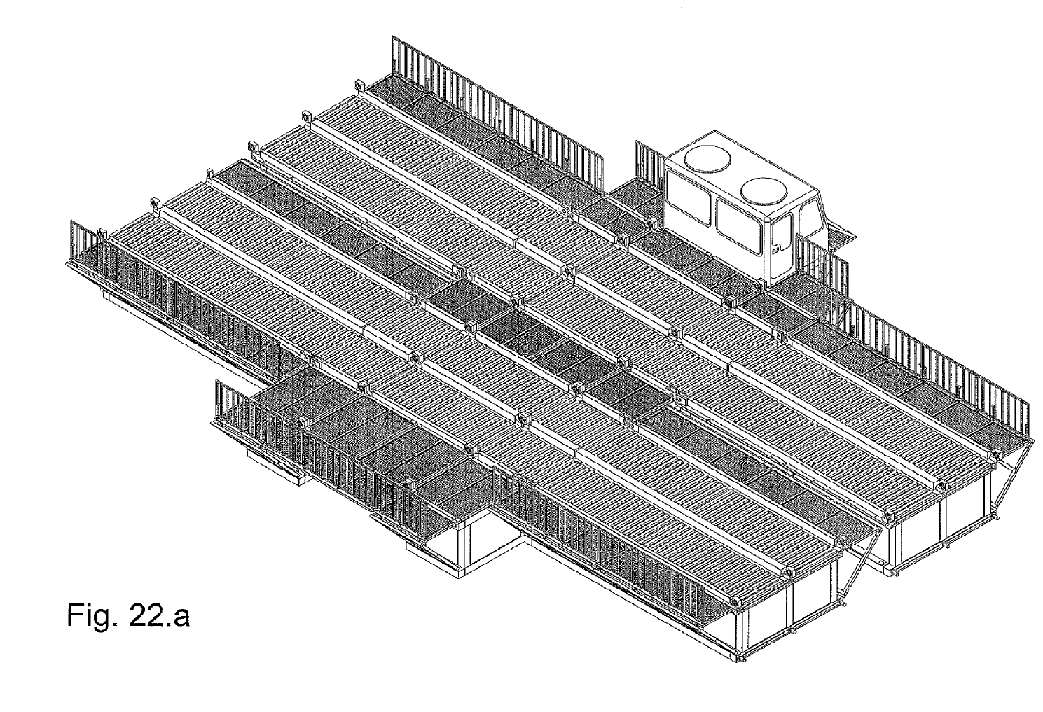

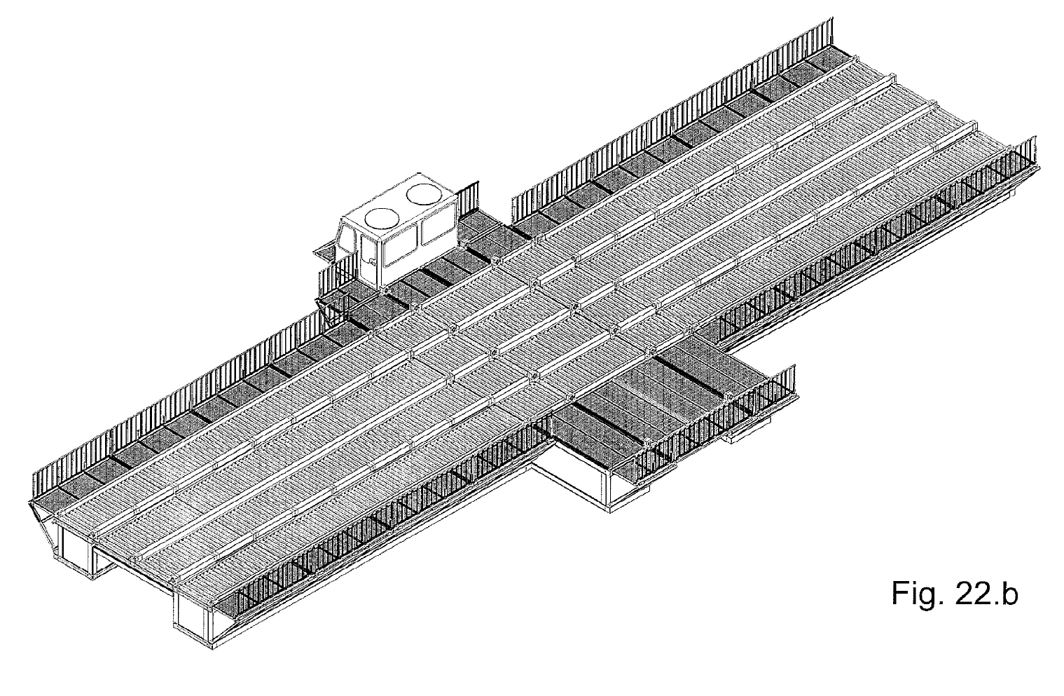

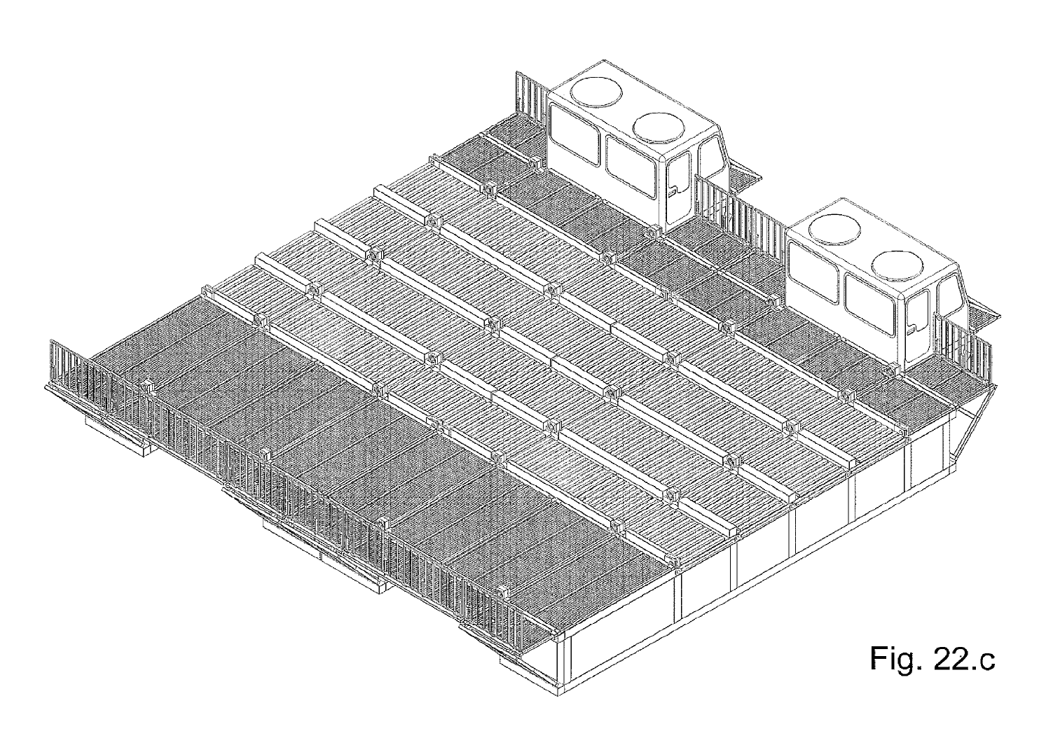

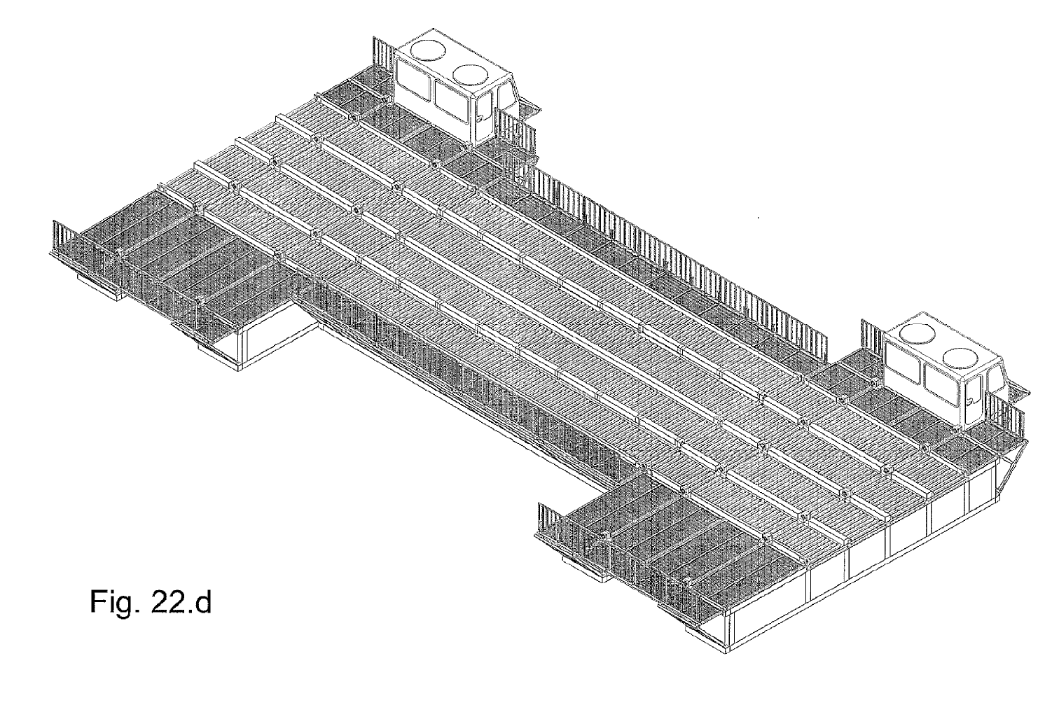

FIG. 22.a shows in a view the exemplary assembly of a piece of ferry and pontoon crossing which comprises a single-track collapsible ferry and singular segments of a single-track collapsible pontoon adjoining it,

FIG. 22.b shows in a view the exemplary assembly of a piece of ferry and pontoon crossing composed of a double-track collapsible ferry and double-track collapsible pontoons adjoining it,

FIG. 22.c shows in a view an exemplary assembly of a segment of ferry crossing composed of two double-track collapsible ferries,

FIG. 22.d shows in a view the exemplary assembly of a segment of ferry crossing composed of two double-track collapsible ferries joined by a double-track collapsible pontoon.

The mobile equipment according to the invention comprises at least one collapsible ferry 1 or one collapsible pontoon 2 having a compact modular design—during the assembly of the crossing equipment in its open condition, out of which floating bridges, ferries or rafts of various types and shapes can be constructed. Modular design of collapsible ferries 1 and collapsible pontoons 2 allows you to fold it to form a trailer or a semi-trailer for the equipment transportation, whereas a self-supporting chassis 3 of a trailer or a semi-trailer remains a basic float module 5 of a collapsible ferry or a basic float module 4 of a collapsible pontoon and forms their inseparable structural and functional part. Stabilising and joining elements of each collapsible ferry 1 and each collapsible pontoon 2 comprising mobile equipment are adapted to be joined together in various sets.

A basic float module 4 of a collapsible pontoon for securing movement using the crossing equipment is a self-supporting chassis 3 of a trailer or a semi-trailer, to which float modules 6 and 7 opened on hinges 10 forwards and backwards or additional float modules 8 and 9 opened sideways on hinges 11 are attached.

A basic float module 4 of a collapsible pontoon is at the same time an enclosure for its required equipment and fittings—including the electrical power system and the hydraulic system, front supports 61 and rear supports 62 and wheels 63 on suspension arms 64 of a trailer or a semi-trailer. Additional float modules, including: front, rear and right-side and left-side modules 6, 7 and 8, 9 respectively are filled in with light foamy structural material 65. Side walls of a basic float module 4 and side walls of additional front and rear or right and left float modules 6 and 7 or 8 and 9 respectively are fitted with breakwaters 66 folded on hinges 67 with walking platforms 68 folded out on hinges 69 and collapsible protective railings 70—blocked in the vertical position with bolts 71, whereas breakwaters 66, platforms 68 and railings 70 in the folded position are accommodated in niches 72 of side walls, as above.

On a basic float module 4 of a single-track collapsible pontoon additional float modules are fixed: a front one 6 and a rear one 7—folded on hinges 10 respectively to the front and to the rear side of a trailer or a semi-trailer, and are stabilised in the open position by means of pins 20 and bushes 21. Securing traffic in the crossing equipment in one direction (one way) is executed with a single track with wooden platforms 16, parallel to the roll axis of a basic float module 4 (the roll axis of a trailer or a semi-trailer)—isolated with thresholds 22 and 23. To extend a single-track collapsible pontoon in the floating version—additional float modules: a front one 6 and a rear one 7 are adapted to be combined with another single-track collapsible pontoon by means of articulated hinge connectors 24, pins 25 and bushes 26. Whereas to convert a single-track collapsible pontoon to a shore version—additional float modules: a front one 6 and a rear one 7 are fitted with sloped thresholds 28 and 29 on articulated joints in an axis 27 with wooden platforms 17—protecting a driveway to the collapsible pontoon and exit from the pontoon, transported in intermodular areas 30 of a pontoon folded to the form of a trailer or a semi-trailer.

On a basic float module 4 of a double-track collapsible pontoon additional side float modules are fixed: a right one 8 and a left one 9—folded on hinges 11 respectively to the right and left side of a trailer or a semi-trailer, and are stabilised in the open position by means of pins 25 and bushes 26. Securing traffic with the use of the crossing equipment in two directions (two way) is executed with tracks which have wooden platforms 16, parallel to the roll axis of the basic float module 4 (the roll axis of a trailer or a semi-trailer)—isolated with sills 31 and 32. To extend a double-track collapsible pontoon in the floating version—additional side float modules: a right one 8 and a left one 9 are adapted to be combined them with another double-track collapsible pontoon by means of articulated hinge connectors 24, pins 25 and bushes 26. Whereas to convert a double-track collapsible pontoon to a shore version—additional side float modules: a right one 8 or a left one 9 are fitted with sloped sills 35, 36, 37 and 38 on articulated joints in axes 33 and 34 with wooden platforms 17—protecting a driveway to the collapsible pontoon and exit from the pontoon, transported in intermodular areas 39 of a pontoon folded to the form of a trailer or a semi-trailer.

A collapsible ferry for securing movement with the use of the crossing equipment with a modular design in its folded state forms a trailer or a semi-trailer, whereas in its open position the self-supporting chassis 3 of a trailer or semi-trailer acts as an additional float module of a pontoon 5, to which self-aligned single float modules or a series of combined additional float modules are attached.

A basic float module 5 of a collapsible ferry is a self-supporting chassis 3 of a trailer or a semi-trailer, to which additional side float modules (12 and 13 respectively) which open on hinges 14 and 15 to the left side and right side are fixed.

On a basic float module 5 of a single-track collapsible ferry additional side float modules are fixed: a right one 12 and a left one 13—folded on hinges 11 to the right and left side of a trailer or a semi-trailer respectively, and are stabilised in the open position by means of pins 20 and bushes 21. Securing traffic with the use of the crossing equipment in two directions (two way) is executed with two single tracks with wooden platforms 18, parallel to theaxis of the basic float module 5 (the roll axis of a trailer or a semi-trailer)—isolated with thresholds 40 and 41 separated with a distance belt 42. To extend a single-track collapsible ferry in the floating version—additional side float modules: a right one 12 and a left one 13 are adapted to be combined with another single-track collapsible ferry, or one single-track collapsible pontoon or two single-truck collapsible pontoons by means of articulated hinge connectors 24, pins 25 and bushes 26. Whereas to convert a single-track collapsible ferry to a shore version—additional side float modules: a right one 12 or a left one 13 are fitted with sloped thresholds 44 and 45 on articulated joints in an axis 43 with wooden platforms 46—protecting a driveway to the collapsible ferry and exit from the ferry, transported in intermodular areas 47 of a ferry folded to the form of a trailer or a semi-trailer.

On a basic float module 5 of a double-track collapsible ferry additional side float modules: a front one 12 and a rear one 13 are fixed—folded on hinges II respectively to the right and left side of a trailer or a semi-trailer, and are stabilised in the open position by means of pins 20 and bushes 21. Protection of traffic in the crossing equipment in two directions (two way) is executed with double tracks with wooden platforms 18, parallel to the axis of the basic float module 5 (the roll axis of a trailer or a semi-trailer)—isolated with sills 50 and 51. To extend a double-track collapsible pontoon in the floating version—additional side float modules: a right one 12 and a left one 13 are adapted to be combined with another double-track collapsible ferry, or one double-track collapsible pontoon by means of articulated hinge connectors 24 and pins 25 and bushes 27. Whereas to convert a double-track collapsible pontoon to a shore version—additional side float modules: a right one 12 or a left one 13 are fitted with sloped sills 54, 55, 56 and 57 on articulated joints in axes 52 and 53 with wooden platforms 58—protecting a driveway to the collapsible ferry and exit from the ferry, transported in intermodular areas 59 of a ferry folded to the form of a trailer or a semi-trailer.

A basic float module 5 of a collapsible ferry forms a basis for a collapsible ferry operator cabin 80 enclosure and an enclosure for required equipment and fittings of a collapsible ferry—including a combustion engine, an electrical power system, a hydraulic system, rear water propellers 81, front water propellers 82, side water propellers 83, front supports 84 and rear supports 85 and wheels 86 on suspension arms 87 of a trailer or a semi-trailer. The remaining additional side float modules: right 12 and left 13 are filled in with light foamy structural material 88. Front walls of a basic float module 5 and side walls of respectively right and left float modules 12 and 13 are fitted with breakwaters 66 folded on hinges 67 with walking platforms 68 folded out on hinges 69 and collapsible protective railings 70—blocked in the vertical position with bolts 71, whereas breakwaters 66, platforms 69 and railings 70 in the folded position are accommodated in niches 72 of side walls, as above.

The driveway to the collapsible ferry is protected by two tracks adjoined to each other parallel to the axis of the basic float module 5 of the roll axis of a trailer or a semi-trailer—isolated with thresholds 90 and 91, whereas the back of the collapsible ferry is fitted with sloped sills 94, 95, 96 and 97 mounted on articulated joints in axes 92 and 93 with wooden platforms 98—protecting a driveway to the collapsible ferry and exit from the ferry, transported in intermodular areas 99 of a ferry folded to the form of a trailer or a semi-trailer.

Single-track collapsible ferries and single-track collapsible pontoons, and double-track collapsible ferries and double-track collapsible pontoons being part of the mobile equipment according to the invention are connected in various combinations thus forming pontoon crossings, ferry and pontoon crossings or ferry crossings.

The presented mobile ferry and pontoon crossing equipment for water obstacles enables the assembly of a crossing from segments (collapsible ferries and pontoons) transported as special, autonomous trailers (semi-trailers) hauled appropriately by road dropside trucks (truck tractors) with high mobility.

The use of the proposed ferry and pontoon crossing equipment with an increased loading capacity will several-times reduce the labour intensiveness of the work required to construct bridge passages. It eliminates the need to engage a substantial number of workers.

1. Mobile pontoon and ferry crossing equipment, consisting of at least a collapsible ferry or a collapsible pontoon, each of which has a compact modular structure composed of float modules and equipped with self-aligned joining elements stabilising these modules, is distinguished by the fact that mat the collapsible ferry (1) or the collapsible pontoon (2) when closed for transportation has the form of a semi-trailer or a trailer, whose self-supporting chassis (3) is at the same time a basic float module of a fbldable ferry (1) or a foldable pontoon (2) respectively.

2. A foldable pontoon for securing movement with the use of the crossing equipment, which has a compact, modular design composed of float modules and equipped with self-aligned joining elements that stabilise these modules, is distinguished by the fact that when closed for transportation it forms a trailer or semi-trailer with a self-supporting chassis (3) being a uniform lower part of the trailer or semi-trailer and additional float modules being an upper part of a trailer or a semi-trailer, whereas in its open position a self-supporting chassis (3) of a trailer or a semi-trailer is at the same time a basic middle float module (4) of a pontoon, to which additional self-aligned single float modules or a series of combined float modules can be attached.

3. A collapsible pontoon according to claim 2 is distinguished by the fact that as an additional float module to the basic float module (4) of a pontoon a front self-aligned float module (6) or rear float module (7) is attached on hinges (10).

4. A collapsible pontoon according to claim 2 is distinguished by the fact mat as an additional float module to the basic float module (4) of a pontoon a right-side self-aligned float module (8) or left-side float module (9) is attached on hinges (11).

5. A collapsible pontoon according to claim 3 is distinguished by the fact that as additional float modules (6) or (7) or (8) or (9) are joined with another module of the additional collapsible pontoon (2) or collapsible ferry (1).

6. A collapsible pontoon according to claim 2 is distinguished by the fact that a basic float module (4) forms an enclosure for, at least, the electrical power system or the hydraulic system, front supports (61) and rear supports (62) and wheels (63) on suspension aims (64) of a trailer or a semi-trailer.

7. A collapsible pontoon according to claim 2 is distinguished by the fact that on float modules of a collapsible pontoon (2) at least one track is located determined by platforms (16) and appropriate sloped thresholds.

8. A collapsible pontoon according to claim 2, distinguished by the fact that additional float modules (6), (7), (8) or (9) of a pontoon (2) are filled with light foamy structural material (65).

9. A collapsible pontoon according to claim 2 is distinguished by the fact mat additional float modules (6), (7), (8) or (9) are fitted with collapsible breakwaters (66).

10. A foldable ferry for securing movement in the crossing equipment which has a compact, modular design composed of float modules and equipped with self-aligned joining elements mat stabilise these modules, is distinguished by the fact that when closed for transportation it forms a trailer or semi-trailer with a self-supporting chassis (3) being a uniform lower part of a trailer or semi-trailer with additional float modules that form an upper part of a trailer or a semi-trailer, whereas in its open position a self-supporting chassis (3) of a trailer or a semitrailer is a basic middle float module (5) of a ferry, to which additional self-aligned single float modules or a series of combined float modules are attached.

11. A collapsible ferry according to claim 10 is distinguished by the fact that as an additional float module, a right-side float module (12) or left-side float module (13) is attached to a basic float module (5) and forms an additional float module is attached on self-aligned hinges (11).

12. A collapsible ferry according to claim 10, is distinguished by the fact that additional side float modules (12) or (13) are joined with another module of an additional collapsible pontoon (2) or a collapsible ferry (1).

13. A collapsible ferry according to claim 10, is distinguished by the fact that a basic float module (S) forms a basis for a ferry operator cabin enclosure (80) and an enclosure for at least a combustion engine, the electrical power system, the hydraulic system, rear water propellers (81), front water propellers (82), side water propellers (83), front supports (84) and rear supports (85) and wheels (86) on suspension arms (87) of a trailer or semi-trailer.

14. A collapsible ferry according to claim 10, is distinguished by the fact that on float modules of a collapsible ferry at least one track is determined by platforms (18) and appropriate sloped thresholds.

15. A collapsible ferry according to claim 10, is distinguished by the fact that additional float modules (12) or (13) are filled with light foamy structural material (88).

16. A collapsible ferry according to claim 10 is distinguished by the fact mat additional float modules (12) or (13) are fitted with collapsible breakwaters (66).
